(19) United States
(12) Patent Application Publication
(10) Pub. No.: US 2009/0007346 A1
(43) Pub. Date: Jan. 8, 2009

(54) Method for Controlling Information Display Using the Avatar in the Washing Machine

(75) Inventors: Mi Kyung Ha, Gyeongsangnam-do (KR); Gyeong Ho Moon, Gyeongsangnam-do (KR); Sang Su Lee, Gyeongsangnam-do (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/791,635

(22) PCT Filed: Jun. 27, 2006
(86) PCT No.: PCT/KR06/02501

§ 371 Date: May 8, 2008

(30) Foreign Application Priority Data
Jun. 30, 2005 (KR) 10-2005-0058251
Jul. 8, 2005 (KR) 10-2005-0061742
Jul. 8, 2005 (KR) 10-2005-0061745
Jul. 8, 2005 (KR) 10-2005-0061747
Jul. 8, 2005 (KR) 10-2005-0061748

(51) Int. Cl. G06F 3/048; G10L 21/06; D06F 33/02; D06F 39/00

(52) U.S. Cl. 8/159; 715/772; 715/706; 715/841; 704/276; 68/12.01; 704/E21.019

(57) ABSTRACT

A method for controlling an information display using an avatar of a washing machine is disclosed, which displays all information associated with usage- and control-information of the washing machine via the avatar, and allows a user of the washing machine to easily recognize the usage- and control-information of the washing machine, resulting in increased information transmission characteristics of the washing machine. Basic usages of the washing machine, and various methods for displaying operation- and control-states of the washing machine will be indicated by at least one dynamic character, such that a user of the washing machine can easily recognize necessary information of the washing machine, resulting in not only increased information transmission characteristics of the washing machine but also emphasized entertainment elements required by modern consumers of the washing machine.

### TECHNICAL FIELD

The present invention relates to a washing machine, and more particularly to a method for controlling an information display using an avatar of a washing machine, which displays all information associated with usage- and control-information of the washing machine via the avatar, and allows a user of the washing machine to easily recognize the usage- and control-information of the washing machine, resulting in increased information transmission characteristics of the washing machine.

### BACKGROUND ART

Typically, a drum washing machine (also called a drum-type washing machine) receives a driving power from a motor on the condition that a detergent, water, and laundry are contained in a drum, such that it performs a washing process using the rotating drum and friction force of the laundry. As a result, the drum washing machine reduces the degree of damage of the laundry, and reduces the degree of entanglement of the laundry, such that it can acquire a superior washing effect capable of effectively beating/twisting the laundry during the washing process.

With the increasing development of a variety of technologies associated with the above-mentioned drum washing machine, the number of functions contained in the drum washing machine has increased, and the number of high-quality washing machines has also increased. Therefore, the number of users who desire to use a drying-drum washing machine capable of performing a washing process, a dehydration process, and a dry process has greatly increased.

A conventional washing machine will hereinafter be described with reference to FIG. 1.

FIG. 1 is a block diagram illustrating a conventional washing machine.

Referring to FIG. 1, a conventional washing machine includes a key input unit 1 for allowing a user to select a desired function from among a variety of functions; a system microprocessor 2 for controlling each process of the washing machine according to a function selected by the key input unit 1; a motor 3 driven by a control signal of the system microprocessor 2; a load drive 4 for driving a variety of loads (e.g., a water-supply valve, and a drain valve, etc.) according to a control signal of the system microprocessor 2; and a display 5 for displaying operations or errors of the function selected by the key input unit 1 according to a control signal of the system microprocessor 2.

If the user presses a specific key of the key input unit 1 to enter a washing command, the system microprocessor 2 of the conventional washing machine transmits a control signal to the motor 3 and the load drive 4 according to the order of a predetermined washing process, and sequentially drives the motor 3, the water-supply valve (not shown), and the drain valve (not shown), such that it performs the washing process.

If the user enters the washing command via the key input unit 1, the system microprocessor 2 outputs a control signal to display user-selected data on the display 5. In this case, the display 5 displays operations times of the washing-, rinsing-, and dehydration-processes for each washing course according to a control signal of the system microprocessor 2, and at the same time displays a remaining washing time.

The above-mentioned conventional washing machine sold to the user acting as a consumer has been widely used as a household appliance at home, and has been generally operated by the user's handling, such that information displayed on the display 5 may greatly affect public confidence of a manufacturing company of the washing machine and system reliability of the washing machine manufactured by the company.

In recent times, a variety of information display methods capable of providing a variety of consumers with correct product information have been proposed.

In this case, the product information includes usages of the washing machine, solutions of faulty operations of the washing machine, and operation states displayed on the display of the washing machine.

Generally, the manufacturing company of the washing machine has manufactured a unique user manual including the above-mentioned usage- and solution-data during a fabrication process of the washing machine, such that the unique user manual can be provided to the user who purchases the washing machine.

### DISCLOSURE OF INVENTION

### Technical Problem

However, it is difficult for the user to intensively read data of the above-mentioned user manual under the condition that no serious problem occurs in the washing machine. And, if the user forgets where the user manual is, the user manual can no longer be used as an information guide by the user.

Generally, current operation states based on individual operations of the washing machine, and information indicating the occurrence of error(s) have been displayed on a small-sized screen instead of a large-sized screen. In this case, the small-sized screen displays the above-mentioned operation states and errors using a data blinking method and a variety of characters.

The above-mentioned conventional information transmission method of the washing machine has a disadvantage in that the user must intensively read the user manual of the washing machine to acquire desired information, resulting in greater inconvenience of the user.

Particularly, provided that the washing machine has a plurality of washing courses classified according to user commands and laundry types, it must correctly inform the user of individual course states. However, the user has difficulty in correctly recognizing the course states due to the limited display function.

Typically, a user unfamiliar with a variety of usages of the washing machine does not know special washing courses other than basic washing courses of the washing machine, such that the user may have difficulty in utilizing high-grade functions of the washing machine.

### Technical Solution

Accordingly, the present invention is directed to an information display control method using an avatar of a washing machine that substantially obviates one or more problems due to limitations and disadvantages of the related art.

An object of the present invention devised to solve the problem lies on an information display control method using an avatar of a washing machine, which displays all information associated with usage- and control-information of the washing machine via the avatar, and allows a user of the washing machine to easily recognize the usage- and control-information of the washing machine, resulting in increased information transmission characteristics of the washing machine.

The object of the present invention can be achieved by providing a method for controlling an information display using an avatar of a washing machine equipped with a display capable of indicating information associated with operation states of the washing machine, the method comprising the steps of: a) specifying an avatar image according to an operation menu; and b) displaying the specified avatar according to operation states of the washing machine.

In another aspect of the present invention, there is provided a method for controlling an information display using an avatar of a washing machine equipped with a display capable of indicating washing information, the method comprising the steps of: a) specifying an avatar image according to categories of the washing information; and b) if a user selects a desired menu in a washing-information explanation mode, displaying a specified avatar appropriate for the selected menu on the display, such that it informs the user of information associated with the selected menu.

In yet another aspect of the present invention, there is provided a method for controlling an information display using an avatar of a washing machine equipped with a display capable of indicating washing course information, the method comprising the steps of: a) displaying a plurality of menus for sequentially providing a user with information of all washing processes; and b) if the user selects a desired menu from among the displayed menus, displaying a specified avatar appropriate for the selected menu on the display, such that it sequentially informs the user of necessary information.

In yet another aspect of the present invention, there is provided a method for controlling an information display using an avatar of a washing machine equipped with a display capable of indicating information associated with operation states of the washing machine, the method comprising the steps of: a) specifying an avatar image for indicating washing information; and b) if a user enters a command for displaying user-confirmed items prior to the beginning of a washing process, displaying the specified avatar on the display, such that it informs the user of information associated with the user-confirmed items.

In yet another aspect of the present invention, there is provided a method for controlling an information display using an avatar of a washing machine equipped with a display capable of indicating information associated with operation states of the washing machine, the method comprising the steps of: a) specifying an avatar image for indicating washing information; and b) if an unexpected error occurs in an operation time of the washing machine, displaying the specified avatar corresponding to the error on the display, and providing the user with information of the error.

Preferably, the displayed avatar includes a specific format and motion capable of specifying a corresponding operation menu.

Preferably, the step a) for specifying the avatar image includes the step of: selecting the avatar image once, such that avatar images of all operation menus of the washing machine are changed to other avatar images.

Preferably, the step a) for specifying the avatar image includes the step of: changing only the avatar image of the selected operation menu to another avatar image, such that the changed avatar image is specified.

Preferably, the step a) for specifying the avatar image includes the steps of: searching for/selecting the avatar image; and establishing not only the motion, size, and speed of the avatar, but also a background color and a background music of the avatar.

Preferably, the step a) for specifying the avatar image includes the steps of: searching for contents stored in an avatar information storage unit of the washing machine; and selecting the searched contents.

Preferably, the step a) for specifying the avatar image includes the steps of: allowing the washing machine to access a server for providing avatar information; and searching for/selecting the avatar image.

Preferably, the selected avatar information is automatically stored in an avatar information storage unit of the washing machine.

Preferably, the step b) for displaying the avatar according to operation states of the washing machine includes the steps of: b1) if the washing machine is driven after the avatar image is specified, determining a current operation menu state; b2) displaying the specified avatar appropriate for the corresponding operation menu state on the display; and b3) if the corresponding operation menu is completely operated, determining a next operation menu state, and re-displaying the specified avatar.

Preferably, the step b) for displaying the avatar according to operation states of the washing machine further includes the step of: generating a specific background music during a predetermined start time or end time of an avatar display period during which the avatar appropriate for the operation state of a corresponding menu is displayed, such that a user can recognize the beginning or ending of the corresponding operation menu by listening to the background music.

Preferably, the avatar has a specific format and motion capable of specifying the avatar, wherein the format and the motion are distinguished from each other by a basic operation menu, wherein the basic operation menu includes a washing process, dehydration process, a water-supply process, a drain process, a drying process, a steam washing process.

Preferably, the avatar has a specific format and motion capable of specifying the avatar, wherein the format and the motion are distinguished from each other by an operation menu, wherein the operation menu includes: a remaining time menu for displaying a remaining time of a washing-, dehydration-, rinsing-, or drying-process, or a remaining time of a total washing time; an error occurrence menu for displaying occurrence of an error or faulty operation of the washing machine during each process; a current temperature menu for displaying an inner temperature of a drum or a water temperature during a current process; and an operation menu explanation menu for informing the user of simple operation methods of the washing machine, or informing the user of a corresponding menu.

Preferably, the method further comprises the step of: if a user clicks on the displayed avatar by moving a cursor from a current location to another location or touches the corresponding avatar on a touch-screen, displaying more detailed sub-menu avatars on the display of the washing machine.

Preferably, a sub-avatar corresponding to the sub-menu and a main-avatar corresponding to a main-menu are simultaneously displayed on the display of the washing machine.

Preferably, the avatar for indicating operation states of the washing machine is displayed, and at the same time voice signals associated with the avatar are generated and characters associated with the avatar are also displayed.

Preferably, the avatar for indicating operation states of the washing machine is displayed, independent of generating voice signals associated with the avatar and displaying characters associated with the avatar.

Preferably, the user is able to a main menu in the washing information explanation mode, wherein the main menu includes: a first menu for explaining washing courses; a second menu for explaining button usages of the washing machine; and a third menu for explaining common-sense washing information.

Preferably, the second menu for explaining the button usages includes a plurality of sub-menus of a button selected from among a variety of function buttons, i.e., a washing button, a rinsing button, a dehydration button, a flowing-water-force button, a water-level button, an On/Off button, and a reservation button.

Preferably, the third menu for explaining the common-sense washing information includes a variety of sub-menus, i.e., a menu associated with a method for removing stains from the laundry, a menu associated with a method for explaining user-confirmed items prior to the beginning of the washing course, a menu associated with a method for explaining usages of a detergent, and a menu associated with a method for reading washing information indicated on the laundry.

Preferably, if the user selects the washing information explanation mode when the washing process begins or is in progress, an avatar capable of specifying a corresponding menu appears, such that it provides the user with necessary information.

Preferably, if the user presses a “Return” key after acquiring desired information, a current operation returns to initial screen images or original operation states.

Preferably, under a condition that the explanation of either a sub-menu selected from the main menu of the washing-course explanation or a sub-menu selected from the main menu of button usages of the washing machine is in progress or is completed, if the user re-selects the corresponding sub-menu, operations of the selected course or operations associated with the pressed button are performed.

Preferably, the menus for sequentially providing the user with necessary washing-process information are a predetermined-course-based washing mode, an only-washing mode, an only-rinsing mode, an only-dehydration mode, a rinsing+dehydration mode, a reserved washing mode, a soak mode, and a water-supply rinsing mode.

Preferably, the predetermined-course-based washing mode includes the steps of: a) displaying a specified avatar to inform the user of a specific message for commanding the user to select a desired course, and allowing the user to select the desired course; b) informing, by the avatar, the user of the selected course, and commanding the user to enter an operation button; and c) if the user presses the operation button by referring to information directed by the avatar, and sequentially performing a selected washing course.

Preferably, the only-washing mode includes the steps of: a) displaying a specified avatar to inform the user of a specific message for commanding the user to select a desired washing time, and allowing the user to select the desired washing time; b) informing, by the avatar, the user of the selected washing time, and commanding the user to press an operation button; and c) if the user presses the operation button by referring to information directed by the avatar, and sequentially performing the washing process during the selected washing time.

Preferably, the only-rinsing mode includes the steps of: a) displaying a specified avatar to inform the user of a specific message for commanding the user to select the number of desired rinsing times, and allowing the user to select the number of desired rinsing times; b) informing, by the avatar, the user of the selected rinsing times, and commanding the user to press an operation button; and c) if the user presses the operation button by referring to information directed by the avatar, and sequentially performing the only-rinsing process according to the user-selected rinsing times.

Preferably, the only-dehydration mode includes the steps of: a) displaying a specified avatar to inform the user of a specific message for commanding the user to select a desired dehydration time, and allowing the user to select the desired dehydration time; b) informing, by the avatar, the user of the selected dehydration time, and commanding the user to press an operation button; and c) if the user presses the operation button by referring to information directed by the avatar, and sequentially performing the only-dehydration process during the user-selected dehydration time.

Preferably, the rinsing+dehydration mode includes the steps of: a) displaying a specified avatar to inform the user of a specific message for commanding the user to select the number of desired rinsing times, and allowing the user to select the desired rinsing times; b) informing, by the avatar, the user of the selected rinsing times, and providing a message for commanding the user to select a desired dehydration time; c) if the user selects the desired dehydration time, informing the user of the selected dehydration time using the avatar, and commanding the user to press an operation button; and d) if the user presses the operation button by referring to information directed by the avatar, sequentially performing the rinsing process and the dehydration process on the basis of the selected rinsing times and the selected dehydration time.

Preferably, the reserved washing mode includes the steps of: a) displaying a specified avatar to inform the user of a specific message for commanding the user to select a desired washing course, and allowing the user to select the desired course; b) informing, by the avatar, the user of the selected washing course, and providing a message for commanding the user to select a desired reservation time; c) informing, by the avatar, the user of the selected washing course and reservation time, and commanding the user to press an operation button; and d) if the user presses the operation button by referring to information directed by the avatar, entering a reservation standby mode on the basis of the selected reservation time, and sequentially performing the washing process according to the selected washing course.

Preferably, the soak mode includes the steps of: a) displaying a specified avatar to inform the user of a specific message for commanding the user to select a desired course, and allowing the user to select the desired course by referring to information directed by the avatar; b) informing, by the avatar, the user of the selected course, and providing a message for commanding the user to press an operation button; c) if the user presses the operation button by referring to information directed by the avatar, detecting an amount of laundry contained in the washing machine, and providing the washing machine with water on the basis of the detected amount of laundry; and d) performing the soak mode after providing the washing machine with the water, and performing the washing process.

Preferably, the water-supply rinsing mode includes the steps of: a) displaying a specified avatar to inform the user of a specific message for commanding the user to select a desired course, and allowing the user to select the desired course by referring to information directed by the avatar; b) informing, by the avatar, the user of the selected course, and providing a message for commanding the user to select a desired water-level, c) if the user selects the desired water-level, commanding the user to select the number of desired water-supply rinsing times using the avatar, such that the user selects the number of desired water-supply rinsing times; d) informing, by the avatar, the user of the selected course, water-level, and water-supply rinsing times, and commanding the user to press an operation button; and e) if the user presses the operation button by referring to information directed by the avatar, sequentially performing the washing process, the water-supply process, and the rinsing process according to user-selected conditions.

Preferably, the user-confirmed items prior to the beginning of the washing process are a laundry-pocket item, a washable-laundry item, a washing-net use item, a separated-washing item, a waterproofing-fiber washing item, a tangled-laundry reduction item, a zip-cloth washing item, and a sweater-washing item.

Preferably, the user-confirmed items are displayed only when the user selects the command for displaying the user-confirmed items.

Preferably, the user-confirmed items are displayed prior to the beginning of the washing process.

Preferably, the error information directed by the avatar includes reason- and solution-information of the error.

Preferably, the method may further comprise the step of: if the error is not solved by the solution information directed by the avatar, allowing the avatar to notify an after-sale service (AS) center of the error information.

Preferably, the method may further comprise the step of: allowing the avatar to inform the user of check points before notifying the AS center of the error information.

### ADVANTAGEOUS EFFECTS

As apparent from the above description, the information display control method using the avatar according to the present invention has the following effects.

Basic usages of the washing machine, and various methods for displaying operation- and control-states of the washing machine will be indicated by at least one dynamic character, such that a user of the washing machine can easily recognize necessary information of the washing machine, resulting in not only increased information transmission characteristics of the washing machine but also emphasized entertainment elements required by modern consumers of the washing machine.

Specifically, the motion of selected avatars is controlled according to a variety of factors (i.e., washing- and drying-process states of the washing machine, operation-state variation of a motor and a load drive), such that the user can recognize current operation states of the washing machine within a short period of time.

Also, the present invention informs the user of a variety of information required for the washing machine using only the avatar without using a user manual of the washing machine, such that the user can effectively use the washing machine.

The washing machine according to the present invention provides the user with the avatar-based washing course, and allows the user to easily check user-defined washing conditions, resulting in greater convenience of the user.

The washing machine according to the present invention informs the user of error- and solution-information of the washing machine using the avatar during the operation time of the washing machine, such that the user can quickly and correctly recognize the error- and solution-information by referring to the avatar.

The washing machine according to the present invention gains access to the server using external devices, such that it can download/store new avatars, resulting more avatars being available for the washing machine.

Also, a variety of operation states of the washing machine are displayed on the display of the washing machine according to the present invention, resulting in increased competitive power.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIG. 1 is a block diagram illustrating a conventional washing machine;

FIG. 2 is a block diagram illustrating a washing machine equipped with an avatar image unit according to the present invention;

FIG. 3 is a flow chart illustrating a method for displaying operation states of a washing machine using an avatar according to the present invention;

FIG. 4 shows exemplary avatar images of individual processes of a washing machine according to the present invention;

FIG. 5 shows exemplary avatar images associated with categories of laundry contained in a washing machine according to the present invention;

FIG. 6 shows exemplary avatar images associated with individual operation states of a washing machine according to the present invention;

FIG. 7 shows exemplary main- and sub-avatars indicating operation states of a washing process according to the present invention;

FIG. 8 shows exemplary main- and sub-avatars indicating operation states of a dehydration process according to the present invention.

FIG. 9 is a flow chart illustrating a method for explaining washing information using an avatar of a washing machine according to the present invention;

FIG. 10 shows exemplary avatar images classified according to individual washing courses of a washing machine according to the present invention;

FIGS. 11˜13 show exemplary screen images displayed when information of a washing course of a washing machine is explained using an avatar according to the present invention;

FIGS. 14˜20 show exemplary screen images displayed when information of keys or buttons of a washing machine is explained using an avatar according to the present invention;

FIGS. 21˜28 show exemplary screen images displayed when common-sense washing information of a washing machine is explained using an avatar according to the present invention;

FIGS. 29˜36 show exemplary screen images displayed when items to be confirmed by a user (i.e., user-confined items) prior to the beginning of a washing process are explained using an avatar according to the present invention;

FIGS. 37˜39 show exemplary screen images displayed when detergent usages of a washing machine are explained using an avatar according to the present invention;

FIGS. 40˜53 show exemplary screen images displayed when washing-course display information is explained using an avatar according to the present invention;

FIGS. 54˜62 are flow charts illustrating methods for providing a user with washing-course information using an avatar of a washing machine according to the present invention;

FIG. 63 shows exemplary avatar images classified according to individual washing courses so as to provide a user with washing-course information using an avatar of a washing machine according to the present invention;

FIGS. 64˜71 show exemplary screen images displayed when an avatar-based washing course is executed according to the present invention;

FIG. 72 is a flow chart illustrating a method for providing a user with attention and solution information using an avatar of a washing machine according to the present invention;

FIGS. 73˜77 show exemplary avatar images for providing a user with category- and solution-information of individual errors of a washing machine according to the present invention; and

FIGS. 78˜80 show exemplary avatar images illustrating checkup points required to be inspected by a user before the user reports the occurrence of errors to an after-sale service (AS) center of the manufacturing company of the washing machine according to the present invention.

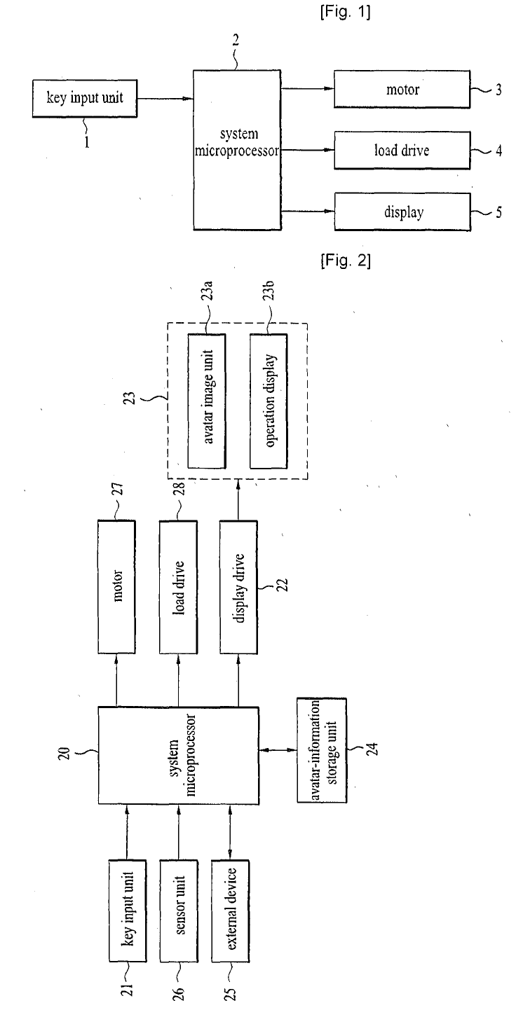

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

An information display control method using an avatar of a washing machine according to the present invention will hereinafter be described with reference to the annexed drawings.

An avatar image processing unit of a washing machine capable of displaying an avatar will hereinafter be described with reference to FIG. 2.

FIG. 2 is a block diagram illustrating a washing machine equipped with an avatar image unit according to the present invention.

Prior to describing the present invention, it should be noted that the information display control method according to the present invention is app lied to a washing machine, and displays usages and operation states of the washing machine using a three-dimensional character (i.e., an avatar), such that it allows a user to easily recognize the displayed information, resulting in increased information transmission characteristics (i.e., increased information visuality) of the washing machine.

As described above, the above-mentioned information transmission method using the avatar allows the user to easily recognize desired information, and emphasizes entertainment factors according to the trend of current consumers, such that the user becomes easily accustomed to a variety of usages of the washing machine.

The term “avatar” is indicative of the incarnation of a specific animation character capable of virtually representing a user in Cyberspace. With the increasing development of Internet technologies, the avatar is indicative of a graphic icon capable of virtually representing the user who plays a three-dimensional (3D) game, a virtual-reality game, or a Web-chatting program on the Internet.

In other words, the avatar is considered to be a virtual object capable of representing the user in a graphic-based virtual society.

Recently, the avatar has been widely applied to a variety of technical fields, for example, a chatting program, an online game, a cyber-shopping mall, a virtual education program, and a virtual office program, etc.

The above-mentioned information display method using the avatar of the washing machine can allow the user to select an avatar-based helper function capable of providing necessary information using the avatar, such that the user can easily learn the above-mentioned information through the medium of the avatar.

According to the present invention, the avatar may be designed to specify each of usage- and control-information of the washing machine, such that it can provide the user with unique information associated with a specific operation. The avatar is designed in different ways according to different operations of the washing machine, such that each avatar represents unique information.

The washing machine equipped with the avatar image unit largely includes a system microprocessor, an avatar image unit, and a storage unit.

The system microprocessor controls overall operations of the washing machine, and controls a display of an avatar to display usage- and control-information of the washing machine. The avatar may indicate a specific operation associated with information to be displayed, and may be designed to represent unique movement associated with the specific operation. The avatar image unit processes/displays an avatar image according to a control signal of the system microprocessor. The storage unit stores information associated with the avatar.

In other words, all the components of the washing machine are controlled by the system microprocessor, and necessary information is displayed via the avatar image according to usages and control states of the washing machine.

Referring to FIG. 2, the washing machine includes a system microprocessor 20, a key input unit 21, a sensor unit 26, a display drive 22, a display 23, and an avatar-information storage unit 24.

The system microprocessor 20 controls a motor 27 for driving a drum (not shown) capable of receiving laundry and a load drive 28 capable of driving a variety of loads (e.g., a water-supply valve, and a drain valve, etc.) to perform a washing-associated process, and controls the processing of avatar-associated images according to operation states and display information categories.

The key input unit 21 allows the user to select a desired washing course from among a plurality of washing courses, and receives a variety of commands for processing the avatar image from the user.

The sensor unit 26 detects a variety of detection values (e.g., a water level, and a temperature, etc.) required for the washing process.

The display drive 22 displays menus and operation states of the selected mode of the washing machine, and outputs a drive signal for displaying an avatar image.

Upon receiving the drive signal from the display drive 22, the display 23 displays menus, operation states, and avatar images of the selected mode of the washing machine.

The avatar-information storage unit 24 stores a variety of avatar images.

In this case, the display 23 includes an avatar image unit 23a for displaying avatar images and an operation display 23b for displaying an operation mode, and a remaining time of the washing machine.

The avatar image unit 23a and the operation display 23b may be integrated into a single display panel, or may be contained in two display panels while being separated from each other, respectively.

If the avatar image unit 23a and the operation display 23b are integrated into a single display panel, an avatar display image is divided into an avatar display area and an operation display area, such that the avatar display area and the operation display area may be simultaneously displayed, or may be sequentially displayed according to a user command.

The above-mentioned washing machine equipped with the avatar image unit according to the present invention includes a communication interface block (not shown).

The system microprocessor 20 is connected to an external device 25 (e.g., a PC, a notebook computer, or a mobile phone capable of accessing a wireless network), downloads avatar information from the external device 25, and stores the downloaded avatar information into an avatar-information storage unit 24.

Needless to say, a washing machine capable of wirelessly accessing a home network may search for desired avatar information without using a connection cable, may download the retrieved avatar information, and may store the downloaded avatar information.

The method for downloading avatar information of a washing machine equipped with the avatar image unit according to the present invention will hereinafter be described with reference to FIG. 2.

Referring to FIG. 2, if the system microprocessor 20 is connected to the external device 25 upon receiving a command from a user, it searches for a desired avatar, and creates a new avatar. After searching for the desired avatar and creating the new avatar, the system microprocessor 20 downloads the avatar information and stores the downloaded avatar information in the avatar-information storage unit 24.

A variety of avatars are stored in the avatar-information storage unit 24. The above-mentioned avatars may be properly selected according to a specific operation state or course selected by the user via the key input unit 21.

When usage- and control-information of the washing machine is displayed, categories or motions of the above-mentioned selected avatars are controlled in different ways according to a variety of display information.

The above-mentioned method for searching for- and creating avatar information may be executed in various ways, and a detailed description thereof will hereinafter be described.

Firstly, any one of external devices gains access to a server for providing avatars over a communication network such as the Internet, searches for a desired avatar or creates a new avatar appropriate for a user's interest, and stores the avatar in an internal memory, such that the downloaded avatar may be downloaded in the avatar-information storage unit 24 via the key input unit 21 of the washing machine.

Secondly, any one of external devices gains access to a unique server managed by the manufacturing company of the washing machine over a communication network, instead of the aforementioned avatar-providing server, searches for desired data from the unique server or creates a new avatar appropriate for a user's interest, and stores the avatar in an internal memory, such that the downloaded avatar may be downloaded in the avatar-information storage unit 24 via the key input unit 21 of the washing machine.

Needless to say, it should be noted that the user may also directly gain access to the aforementioned server via the key input unit 21 of the washing machine, instead of searching for/creating a desired avatar using the external device. Therefore, the user may search for, create, and store the avatar simultaneously with viewing information displayed on the display 23.

For this purposes, the system microprocessor 20 or the display microprocessor (not shown) includes a specific software program capable of optimizing the downloaded avatar image according to operation- and control-states of the washing machine, and displaying the optimized avatar image.

If the user gains access to the unique server managed by the manufacturing company of the washing machine, the user may freely download a new-version software program from the server, such that the old-version software program is updated with the new-version software program.

Any one of the aforementioned downloaded avatars stored in the avatar-information storage unit 24 is selected by the user via the key input unit 21. The selected avatar changes in different motions, colors, and shapes according to categories and contents of information displayed on the washing machine.

Needless to say, it should be noted that different avatars may be established according to categories or contents of information to be displayed.

In addition, a voice output unit (not shown) may output a variety of voice signals associated with a variety of motions of the selected avatar.

If required, the avatar may also be displayed on a remote-control monitor capable of controlling the washing machine at a remote site, such that information transmission characteristics are improved during the remote control-monitoring process of the washing machine.

A method for displaying operation states of the washing machine from among a variety of information display control methods of the washing machine kill hereinafter be described.

The method for displaying operation states using the avatar can be basically classified into a process for selecting an avatar and a process for displaying operation states using the selected avatar.

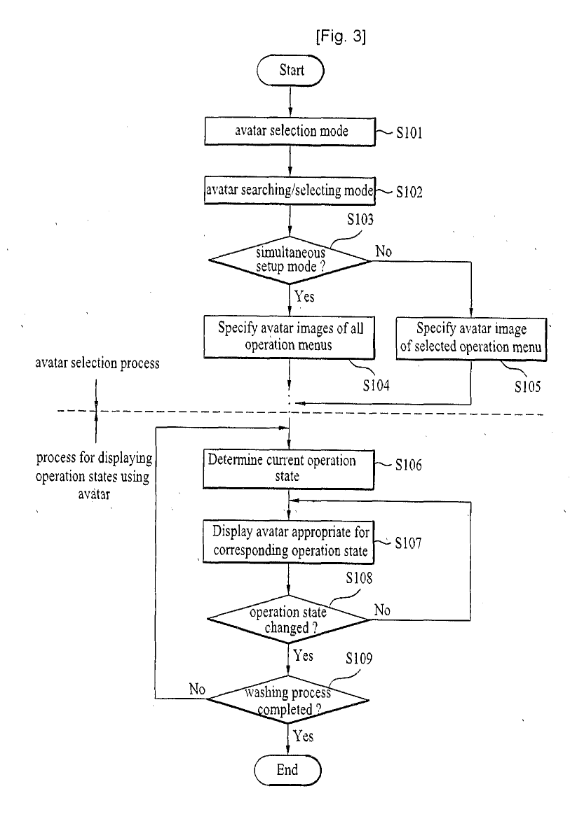

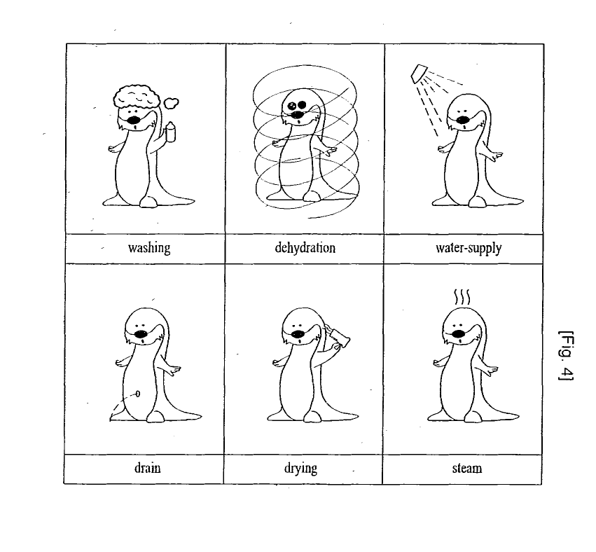

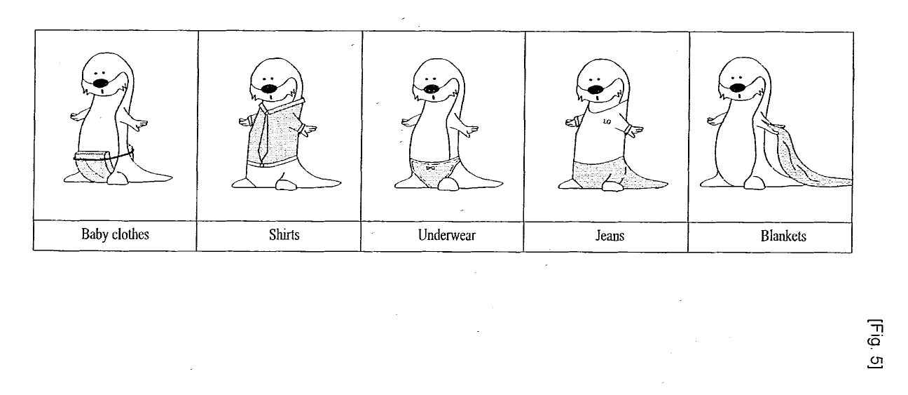

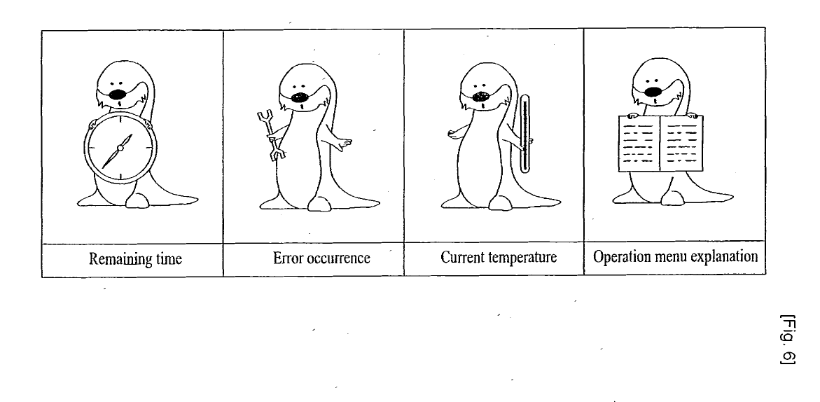

FIG. 3 is a flow chart illustrating a method for displaying operation states of a washing machine using an avatar according to the present invention.

Referring to FIG. 3, the above-mentioned avatar selection process enters an avatar selection mode at step S101, and searches for/selects a desired avatar from among a plurality of avatars stored in the avatar-information storage unit at step S102.

In this case, the above-mentioned avatar searching/selecting process may establish not only the motion, size, and speed of the avatar, but also a background color and a background music of the avatar.

Also, the above-mentioned avatar searching/selecting process may be executed by information stored in the avatar-information storage unit, and may be connected to a server for providing avatar information or a server of a manufacturing company of the washing machine via an external device, such that it may be executed simultaneously with downloading the avatar information from the server.

The avatar searching/selecting process determines whether an avatar image setup is a simultaneous setup mode at step S103.

If the avatar image setup is equal to the simultaneous setup mode at step S103, avatar images of all the operation menus are changed to selected images, such that the resultant avatar images are determined at step S104.

If the avatar image setup is different from the simultaneous setup mode at step S103, avatar images of the selected operation menu are changed to selected images, such that the resultant avatar images are determined at step S105.

If the avatar image setup is executed by an individual setup mode instead of the simultaneous setup mode, different avatars display current operation states according to operation menus.

For example, in the case of the individual setup mode, a washing process may display operation states using an otter-shaped avatar, and a dehydration process may display operation states using a fur-seal-shaped avatar.

If the washing process is performed by a user under the aforementioned condition that the avatar image setup has been completed, the process for displaying operation states using the avatar is executed as follows.

If the washing process is in progress, the current operation states of the washing machine are determined at step S106.

A specified avatar appropriate for a corresponding operation state is displayed on the display at step S107.

In this case, the motion and environment of the avatar displayed on the display are controlled by information predetermined by the user.

As described above, the process for displaying operation states using the avatar is continuously executed until a current operation state is changed to another operation state.

If the current operation state is changed to another operation state at step S108, and all of the washing process is not completed at step S109, the current operation state is re-determined, such that the avatar appropriate for a corresponding operation state is displayed.

The washing machine outputs a specific background music during a predetermined start time or end time of an avatar display period during which the avatar appropriate for the operation state of a corresponding menu is displayed, such that the user can recognize the beginning or ending of the corresponding operation menu by listening to the background music.

Avatar configuration for use in the above-mentioned process for displaying operation states using the avatar will hereinafter be described in detail.

For the convenience of description, the avatar is determined by the simultaneous setup mode, and is configured in the form of an otter-shaped image as an example of the present invention.

FIG. 4 shows exemplary avatar images of individual processes of a washing machine according to the present invention.

FIG. 4 shows unique otter-shaped avatar images for specifying individual process, states of the washing machine. A variety of basic operation menus (e.g., a washing process, dehydration process, a water-supply process, a drain process, a drying process, a steam washing process, etc.) of the washing machine are indicated by different otter-shaped avatar images.

Needless to say, other operation menus may also be added to the above-mentioned basic operation menus as necessary.

FIG. 5 shows exemplary avatar images associated with categories of laundry contained in a washing machine according to the present invention.

FIG. 5 shows different otter-shaped avatar images for indicating different categories of laundry, for example, baby clothes, shirts, underwear, jeans, and blankets, etc.

FIG. 6 shows exemplary avatar images associated with individual operation states of a washing machine according to the present invention.

FIG. 6 shows a plurality of otter-shaped avatar images for indicating different operation states, for example, a remaining time, an error occurrence, a current temperature, and an operation menu explanation, etc.

The otter-shaped avatar image for indicating the remaining time displays a remaining time of the washing-, dehydration-, rinsing-, or drying-process, or a remaining time of a total washing time.

The otter-shaped avatar image for indicating the error occurrence displays the occurrence of errors or faulty operation of the washing machine during each process.

The otter-shaped avatar image for indicating the current temperature displays an inner temperature of a drum or a water temperature, etc. during a current process.

The otter-shaped avatar image for indicating the operation menu explanation informs the user of simple operation methods of the washing machine, or informs the user of a corresponding menu.

The above-mentioned avatar images for displaying individual operation states are given as examples of the present invention. Needless to say, other avatar images may also be added to the present invention as necessary.

If the user clicks on a corresponding avatar by moving a cursor from a current location to another location or touches the corresponding avatar on a touch-screen, more detailed sub-menus may be displayed on the display of the washing machine.

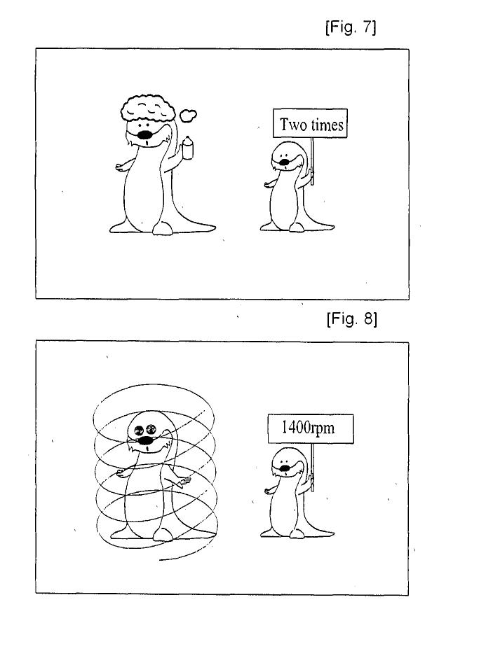

FIG. 7 shows exemplary main- and sub-avatars indicating operation states of a washing process according to the present invention. FIG. 8 shows exemplary main- and sub-avatars indicating operation states of a dehydration process according to the present invention.

Referring to FIG. 7, a main avatar indicates a washing process is in progress, and a sub-avatar indicates that a current washing process is a second washing process.

Referring to FIG. 8, a main avatar indicates a dehydration process is in process, and a sub-avatar indicates a current dehydration process is being executed at 1400 rpm.

As can be seen from FIGS. 7˜8, the washing machine according to the present invention simultaneously displays the main avatar and the sub-avatar, instead of displaying current operation states using only one avatar, such that it can provide the user with more accurate information.

As described above, the above-mentioned process for displaying operation states using the avatar may display only the avatar on the display. Furthermore, the above-mentioned process for displaying operation states using the avatar may display specific characters on the display simultaneously displaying the avatar on the display, and at the same time may output voice signals as necessary.

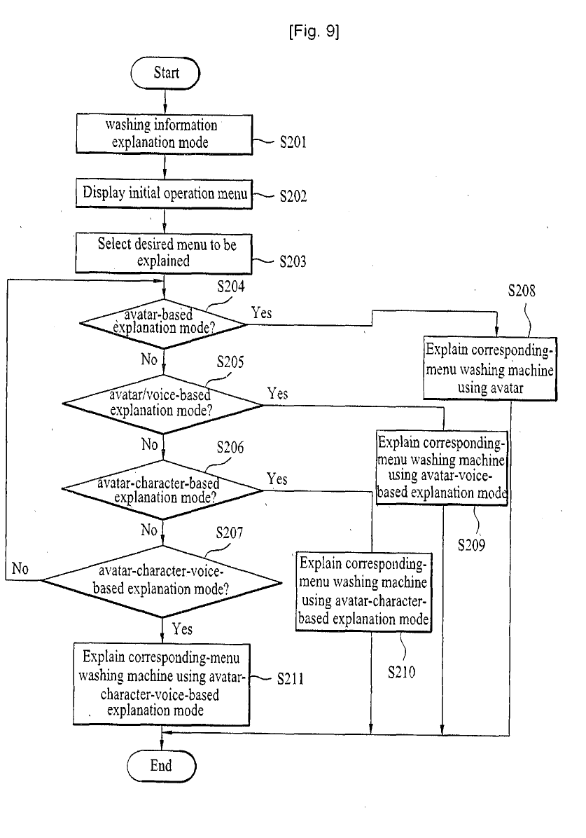

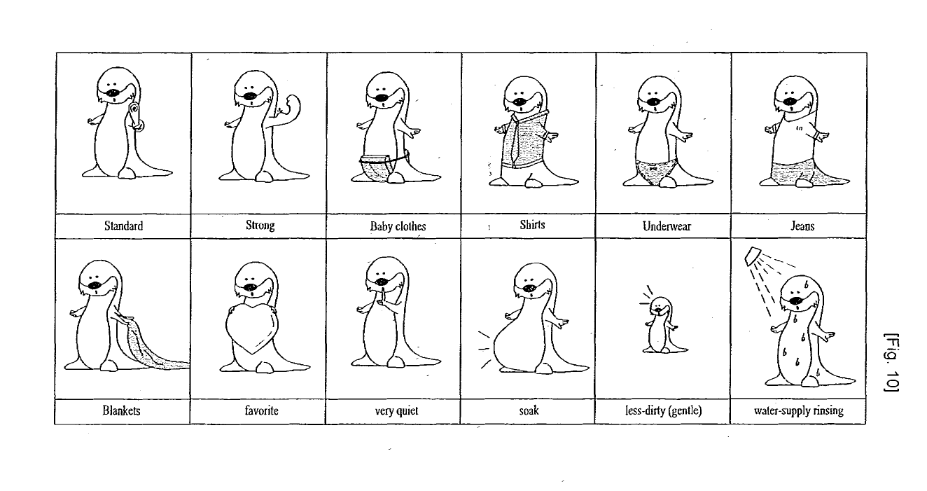

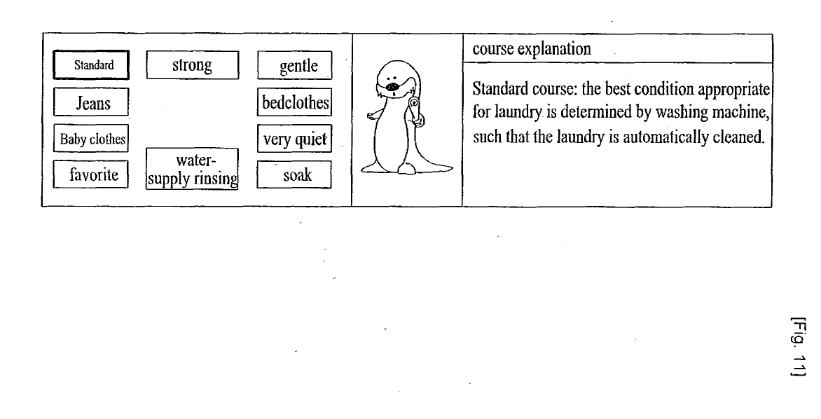

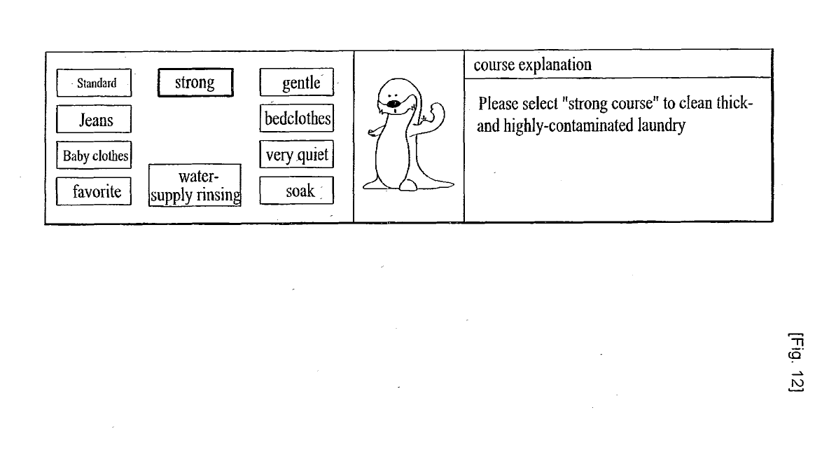

FIG. 9 is a flow chart illustrating a method for explaining washing information using an avatar of a washing machine according to the present invention.

Referring to FIG. 9, the method for explaining washing information using the avatar of the washing machine according to the present invention can be basically classified into a process for selecting a desired menu from among a plurality of menus and a process for explaining washing information using the specified avatar.

The method for explaining washing information according to the present invention can be classified into a first process for explaining a washing course, a second process for explaining buttons of the washing machine, and a third process for explaining common-sense washing information.

The first process for explaining the washing course describes a variety of washing courses using the avatar, for example, a standard washing course, a strong washing course, a turbo-stream washing course, a favorite washing course, and a less-dirty washing course (also called a gentle washing course).

The second process for explaining buttons of the washing machine describes a variety of button operation options using the avatar, for example, a washing button, a rinsing button, a dehydration button, a water-level button, an On/Off button, a reservation button, a rotary knob button, and a favorite-course selection button, etc.

The third process for explaining the common-sense washing information describes a variety of common-sense washing information using the avatar, for example, a method for removing stains from the laundry, a method for explaining user-confirmed items prior to the beginning of the washing course, a method for explaining usages of a detergent, and a method for reading washing information indicated on the laundry.

The above-mentioned washing information explanation using the avatar will hereinafter be described.

Firstly, the above-mentioned washing information explanation may be executed using only the avatar.

Secondly, the above-mentioned washing information explanation may be executed simultaneous with displaying the avatar and its associated characters.

Thirdly, the above-mentioned washing information explanation may be executed by displaying the avatar, and at the same time may output voice signals associated with the avatar.

Fourthly, the above-mentioned washing information explanation may be executed by displaying the avatar and associated characters, and at the same time may output voice signals associated with the avatar.

Although exemplary screen images shown in FIGS. 10 to 53 disclose avatars and associated characters, it should be noted that washing information explanation may also be executed by other examples other than the above-mentioned exemplary screen images.

Referring to FIG. 9, if the washing machine enters a washing information explanation mode on the condition that the avatar was specified at step S201, it displays an main menu for explaining information at step S202.

If the main menu is selected and a user of the selected main menu selects a desired lower mode to be explained at step S203, and if the setup mode for explaining the corresponding menu is an avatar-based explanation mode at step S204, the washing machine explains the washing machine information of the corresponding menu using the avatar at step S208.

If the setup mode for explaining the corresponding menu is equal to an avatar/voice-based explanation mode at step S205, the washing machine explains the washing information of the corresponding menu using the avatar/voice output function at step S209.

If the setup mode for explaining the corresponding menu is equal to an avatar-character-based explanation mode at step S206, the washing machine explains the washing information of the corresponding menu using the avatar at step S210.

If the setup mode for explaining the corresponding menu is equal to an avatar/voice/character-based explanation mode at step S207, the washing machine explains the washing information of the corresponding menu using the avatar at step S211.

The above-mentioned different explanation methods are appropriately established in consideration of complexity and information transmission characteristics of the explained contents.

As for the above-mentioned washing information explanation, if the user selects the washing information explanation mode when the washing process begins or is in progress, an avatar capable of specifying a corresponding menu appears to provide the user with necessary information.

Under the condition that the explanation of either a sub-menu selected from the main menu of the washing-course explanation or a sub-menu selected from the main menu of button usages of the washing machine is in progress or is completed, if the user re-selects the corresponding sub-menu, operations of the selected course or operations associated with the pressed button may be performed.

If the user presses a “Return” key after acquiring desired information, a current operation returns to initial screen images or original operation states.

The Return key's entry is conducted by an additional key's entry, however, it should be noted that the Return key may also be selected by double-clicking on the avatar image or by selecting an main menu by moving the cursor to another location.

The washing information explanation using the avatar will hereinafter be described with reference to the annexed drawings.

For the convenience of description, the avatar is configured in the form of an otter-shaped image, and the washing information is explained according to the avatar/character display method.

FIG. 10 shows exemplary avatar images classified according to individual washing courses of a washing machine according to the present invention.

FIG. 10 shows exemplary avatar images for specifying individual washing courses using the otter-shaped avatars. Needless to say, other operation menus may also be added to the above-mentioned avatar images as necessary.

FIGS. 11˜13 show exemplary screen images displayed when information of a washing course of a washing machine is explained using an avatar according to the present invention.

FIG. 11 shows an exemplary avatar image for specifying a standard course when the user selects the explanation of the standard course, such that the avatar image of FIG. 11 informs the user of the standard course.

FIG. 12 shows an exemplary avatar image for specifying a strong course when the user selects the explanation of the strong course, such that the avatar image of FIG. 12 informs the user of the strong course.

FIG. 13 shows an exemplary avatar image for specifying a less-dirty course when the use selects the explanation of the less-dirty course, such that the avatar image of FIG. 13 informs the user of the less-dirty course.

Although FIG. 13 shows only a small-sized avatar image for the convenience of description, it should be noted that a large-sized avatar image initially appears and then the small-sized avatar image appears, such that the motion patterns of the large- or small-sized avatar images are repeated in the order of specific motions.

If the avatar/voice output mode is established instead of the avatar/character display mode, the motion range of the avatar is extended to the character display range, and contents of the character is outputted via voice signals.

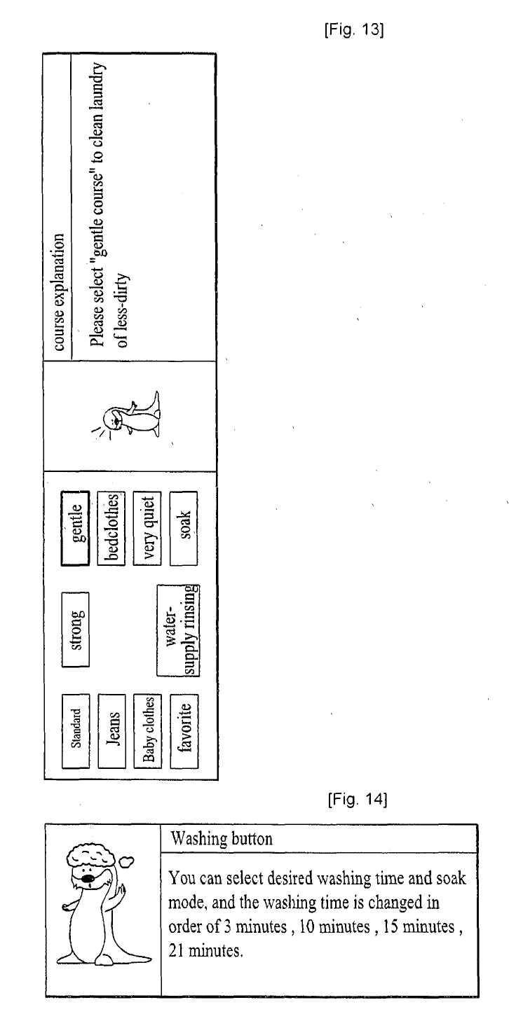

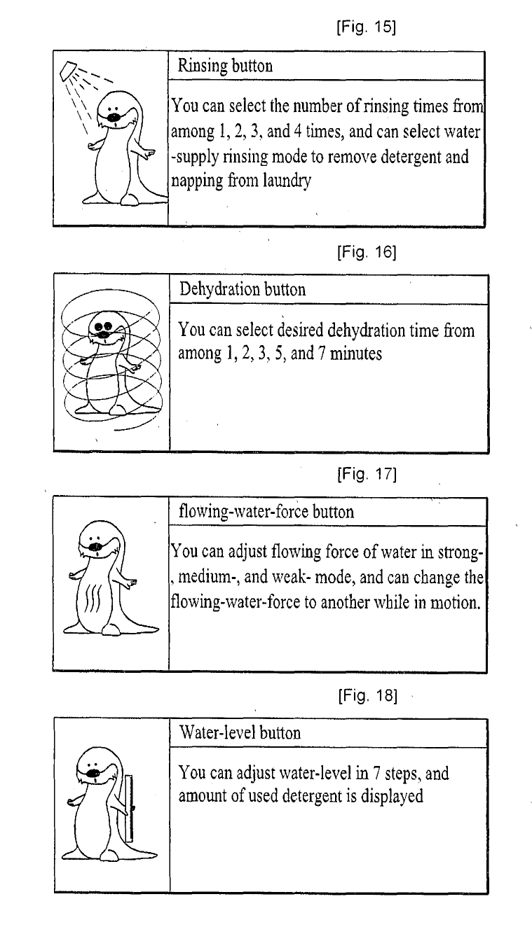

FIGS. 14˜20 show exemplary screen images displayed when information of keys or buttons of a washing machine is explained using an avatar according to the present invention.

FIGS. 14˜20 show exemplary avatar images for explaining a variety of buttons selected by the user who enters the washing information explanation mode.

The buttons to be explained may be selected by the user via a sub-menu displayed on the screen, or may be selected by the user who presses actual buttons in the washing information explanation mode.

If the user selects the button by pressing the actual buttons in the washing information explanation mode, the user-pressed button is used to request explanation of the pressed button from the server, instead of performing operations associated with the pressed button.

A variety of avatar images of FIGS. 14˜20 specify a washing button, a rinsing button, a dehydration button, a flowing-water-force button, a water-level button, an On/Off button, and a reservation button. If the user selects a desired function from among a plurality of functions, an avatar image appropriate for the user-selected function appears, such that it informs the user of the corresponding button's function.

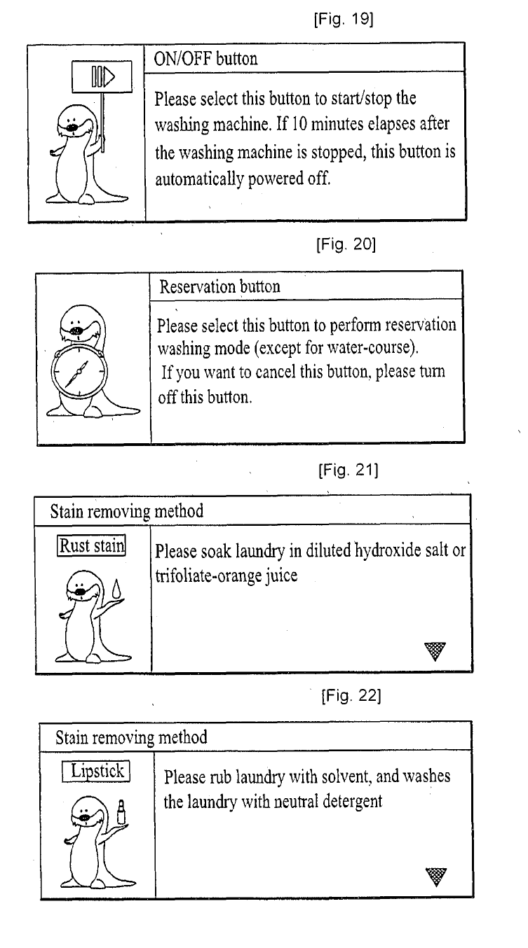

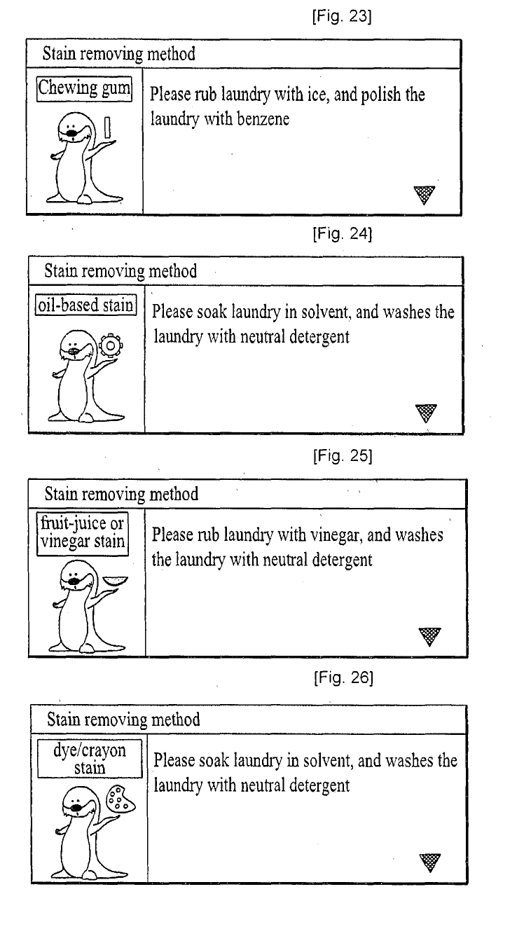

FIGS. 21˜28 show exemplary screen images displayed when common-sense washing information of a washing machine is explained using an avatar according to the present invention.

If the user enters the washing information explanation mode to learn the stain removing method from the common-sense washing information, the avatar images of FIGS. 21˜28 inform the user of a variety of stain removing methods classified according to stain categories.

There are a variety of stains of laundry, for example, a rust stain, a lipstick, a chewing gum, an oil-based stain, a fruit-juice or vinegar stain, a dye/crayon stain, an iron-heated stain, and a blood stain. The avatar images of FIGS. 21˜28 inform the user of the methods for removing a variety of stains which are difficult to be removed by general washing courses.

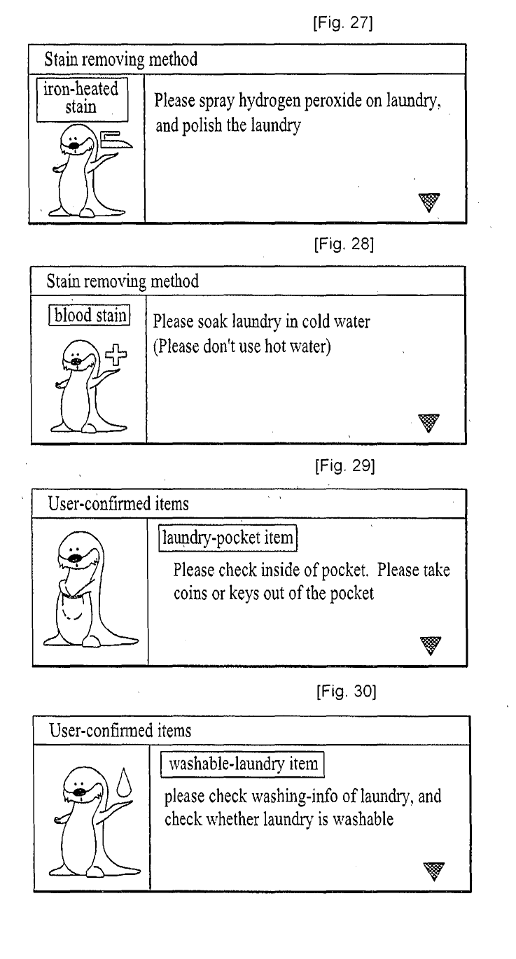

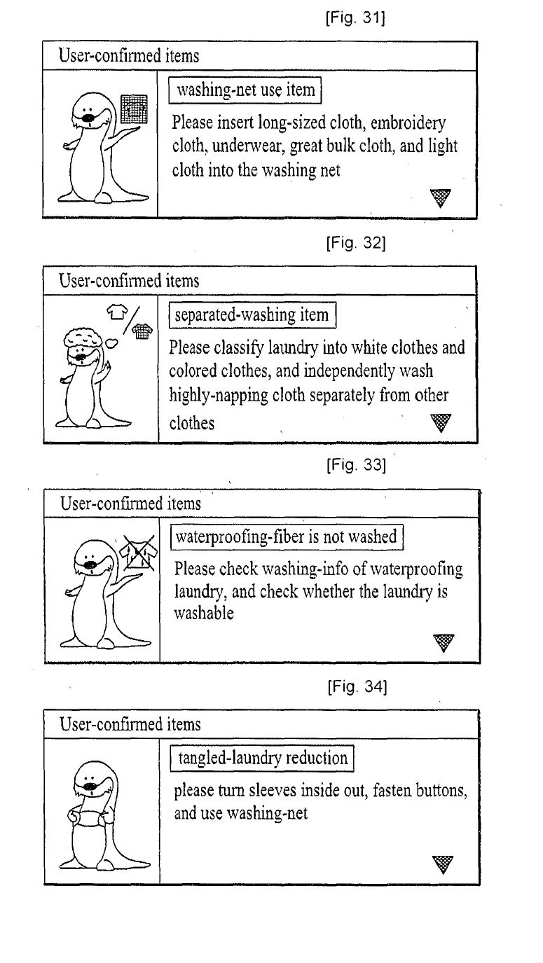

FIGS. 29˜36 show exemplary screen images displayed when items to be confirmed by a user (i.e., user-confirmed items) prior to the beginning of a washing process are explained using an avatar according to the present invention.

The user-confirmed items are explained only when the user desires to view the user-confirmed items in the washing information explanation mode. The user-confirmed items are explained prior to the beginning of the washing process.

There are a variety of sub-menus of the user-confirmed items, for example, a laundry-pocket item, a washable-laundry item, a washing-net use item, a separated-washing item, a waterproofing-fiber washing item, a tangled-laundry reduction item, a zip-cloth washing item, and a sweater-washing item, etc. If the user selects any one of the above-mentioned items, a specific avatar image for specifying the user-selected item appears, such that it informs the user of the corresponding washing information.

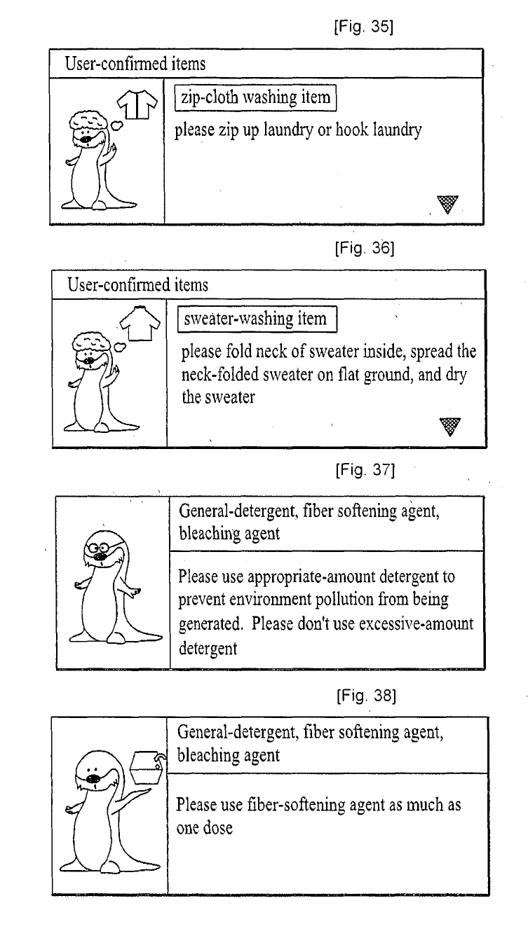

FIGS. 37˜39 show exemplary screen images displayed when detergent usages of a washing machine are explained using an avatar according to the present invention.

The detergent usages of the washing machine are explained only when the user desires to view the detergent usages in the washing information explanation mode. There are a variety of detergent usages, for example, a general-detergent usage, a fiber softening agent usage, and a bleaching agent usage.

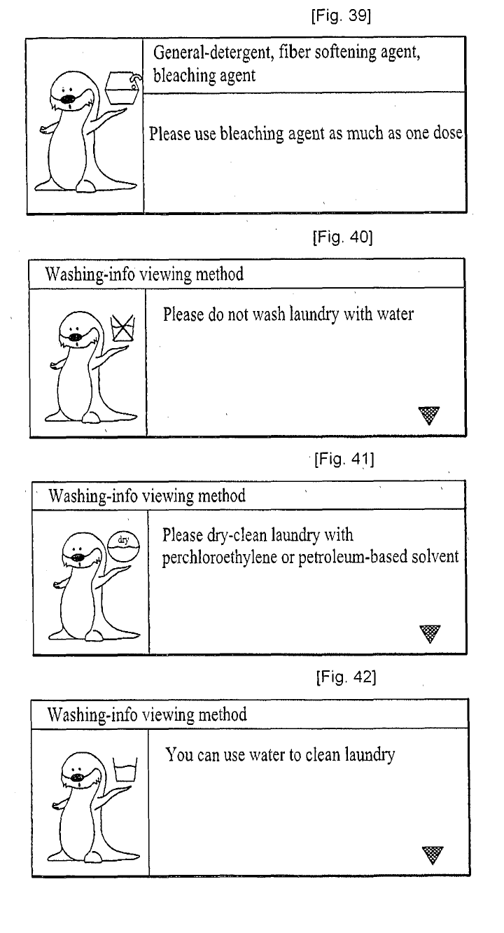

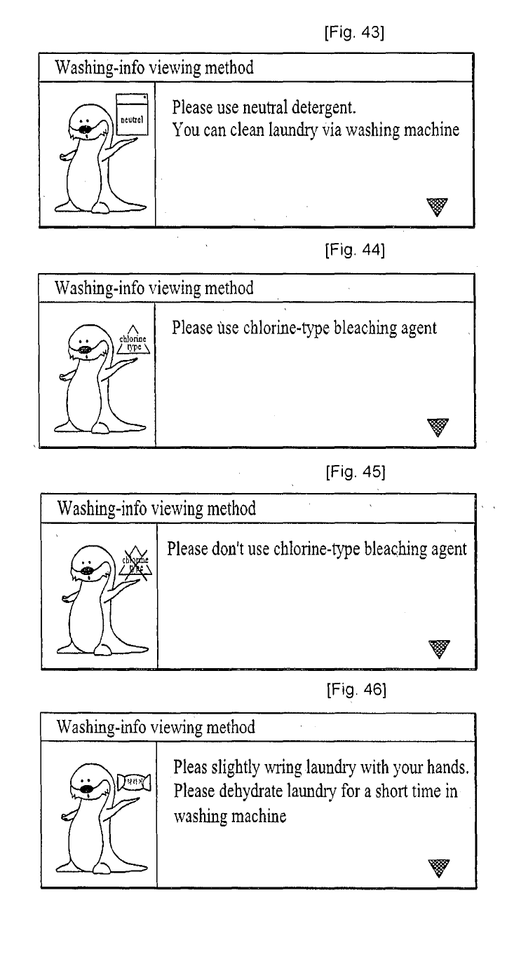

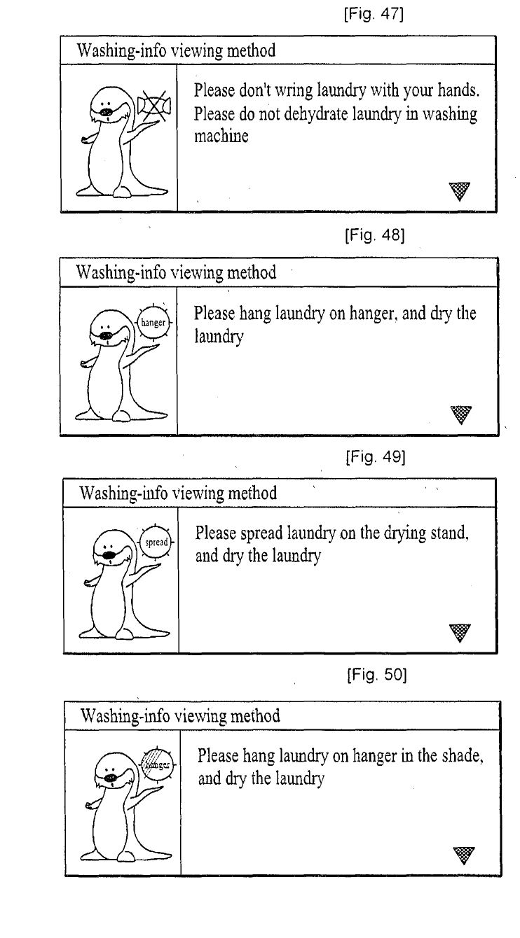

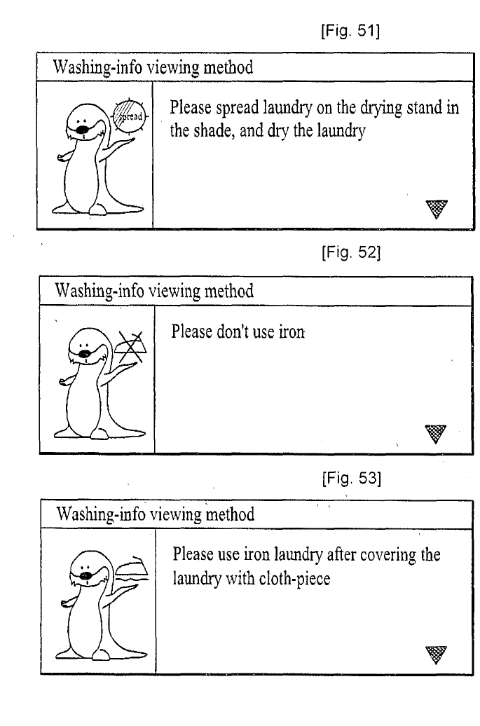

FIGS. 40˜53 show exemplary screen images displayed when washing-course display information is explained using an avatar according to the present invention.

The washing-course display information explains marks printed on the laundry. The washing-course display information is explained when the user desires to view correct information of a specific mark from among a plurality of marks in the washing information explanation mode.

If the user selects a desired menu associated with a desired mark, an avatar for specifying the selected mark informs the user of detailed information of the selected mark.

Although FIGS. 40˜53 explain user-desired washing information using only one avatar for illustrative purposes, it should be noted that the main avatar and the sub-avatar may be simultaneously displayed on the display of the washing machine so as to provide the user with more correct information.

Needless to say, it should be noted that the motion, speed, and shape of the avatar may be variable, and the size and color of the avatar may also be variable.

The method for explaining washing information using the avatar of the washing machine according to the present invention allows the user to easily recognize effective washing information by referring to the avatar without reading the user manual of the washing machine, resulting in the implementation of effective use of the washing machine.

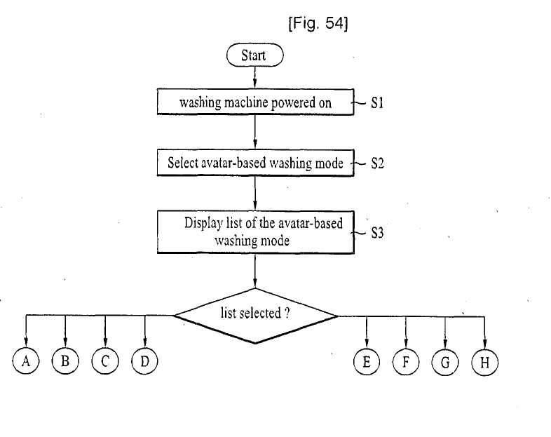

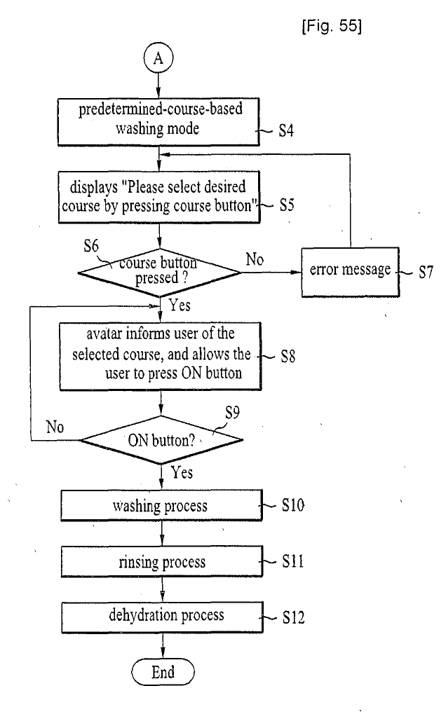

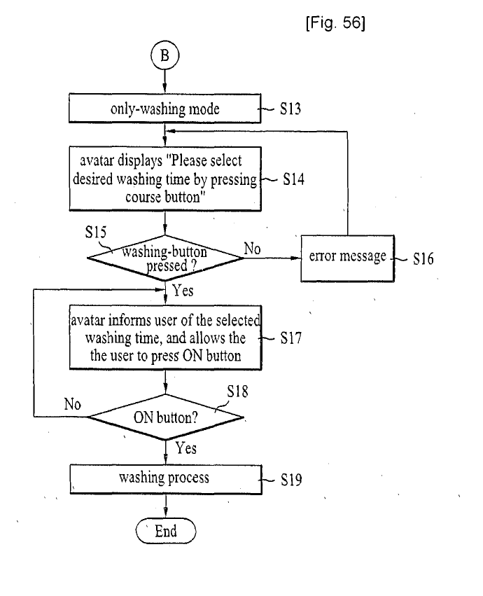

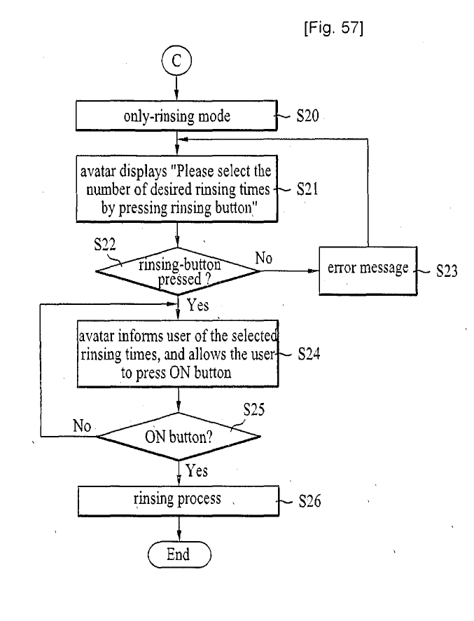

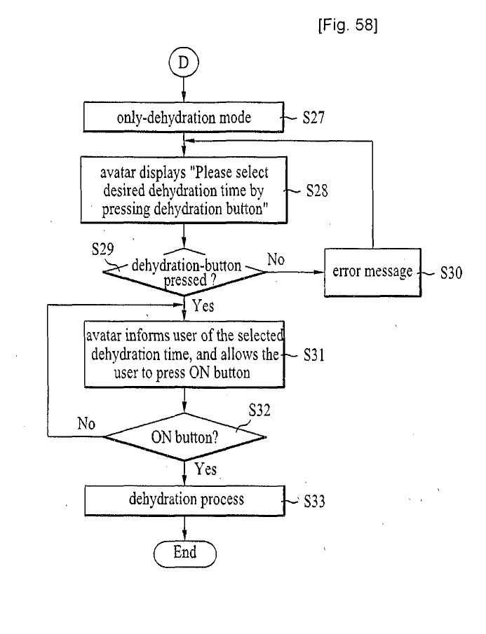

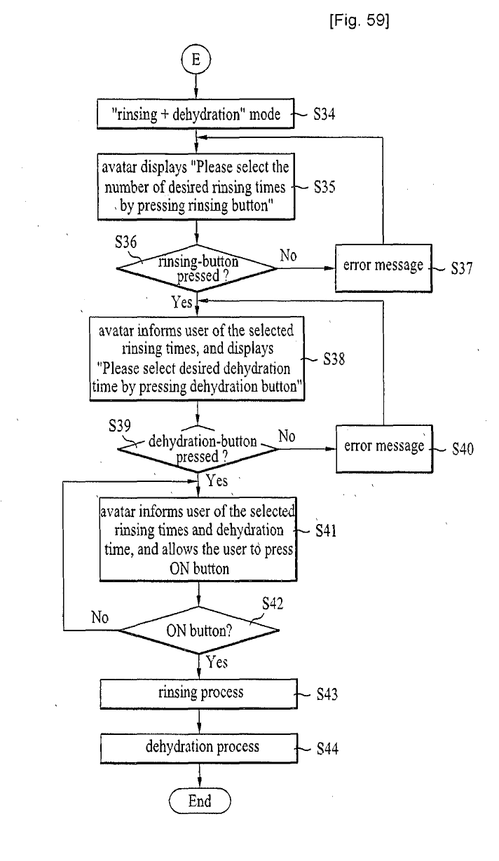

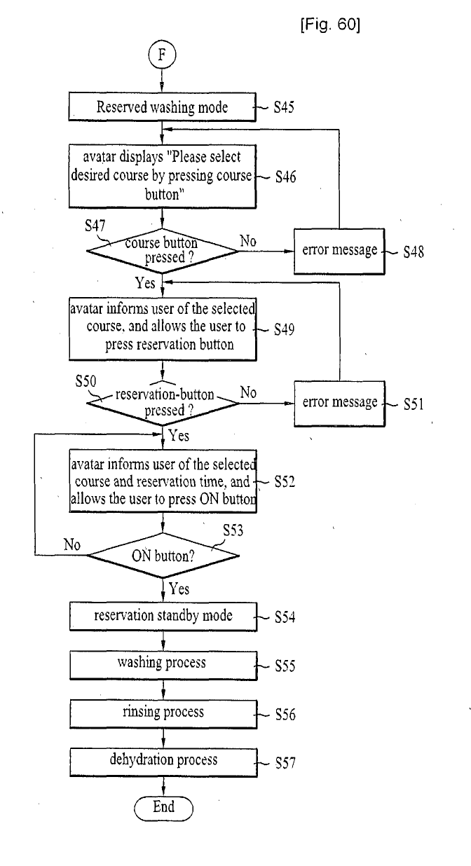

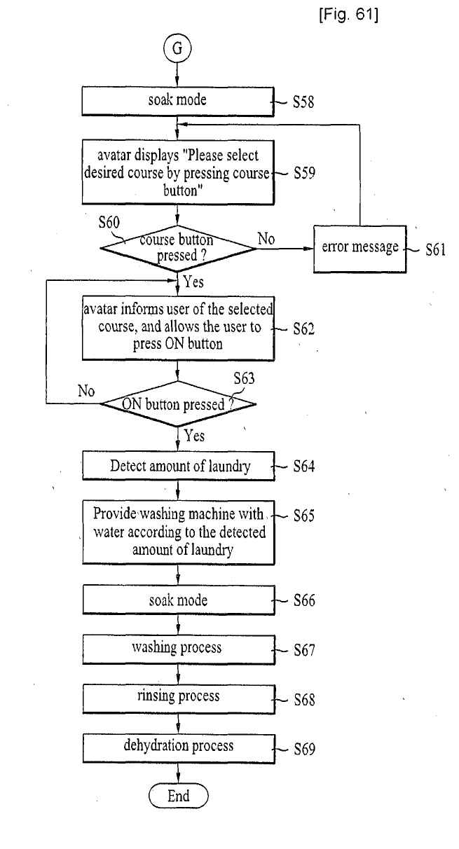

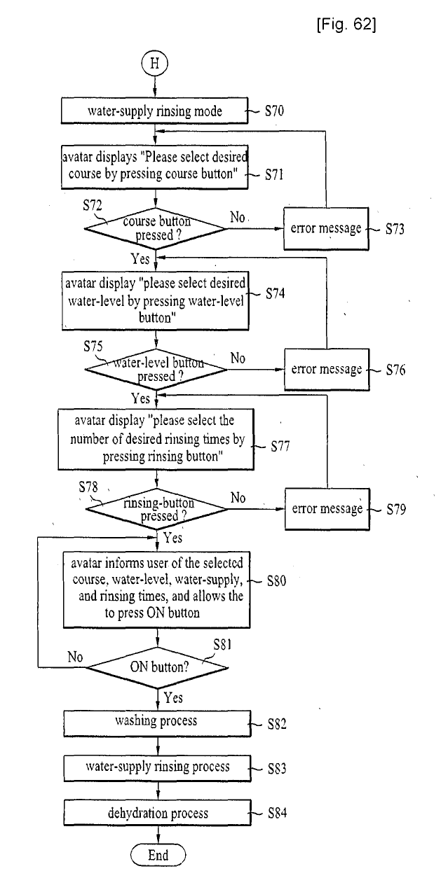

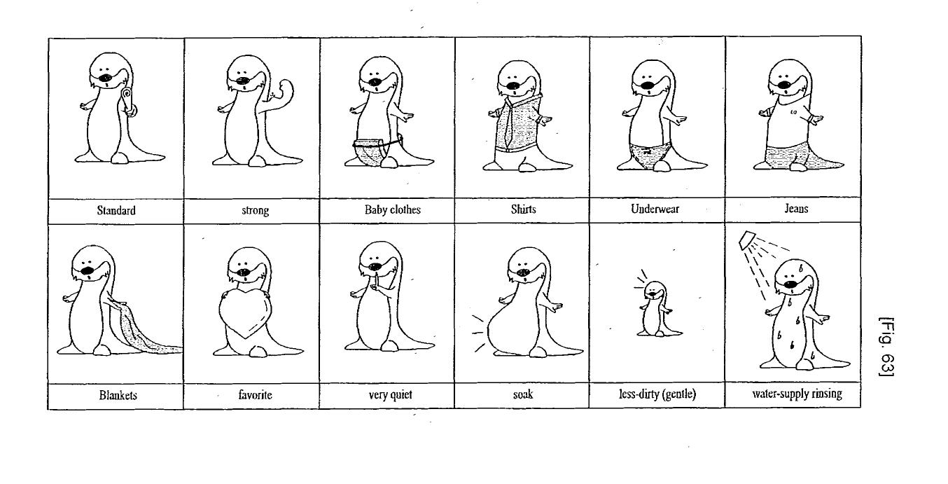

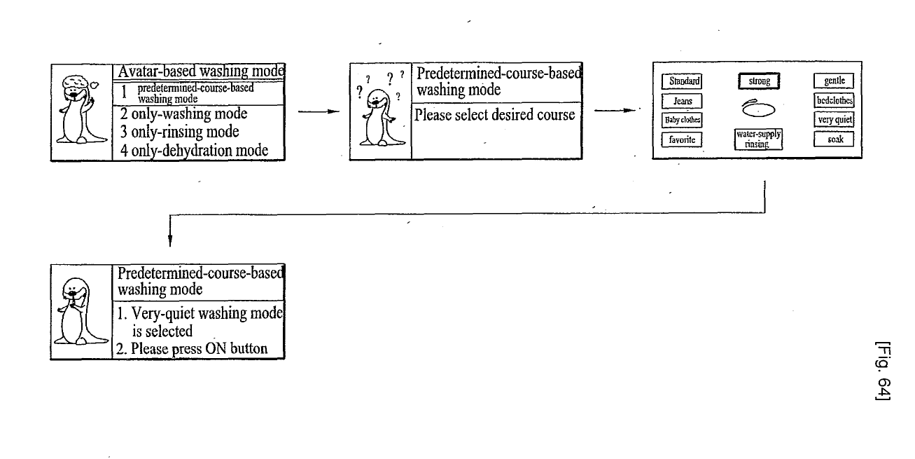

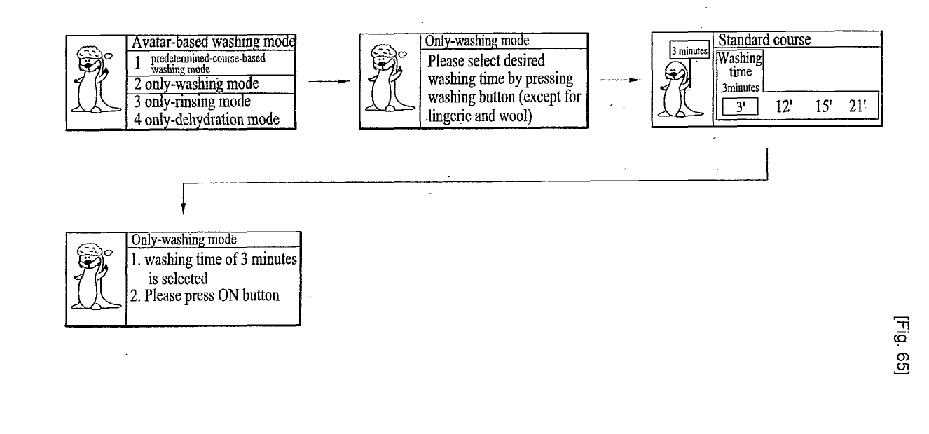

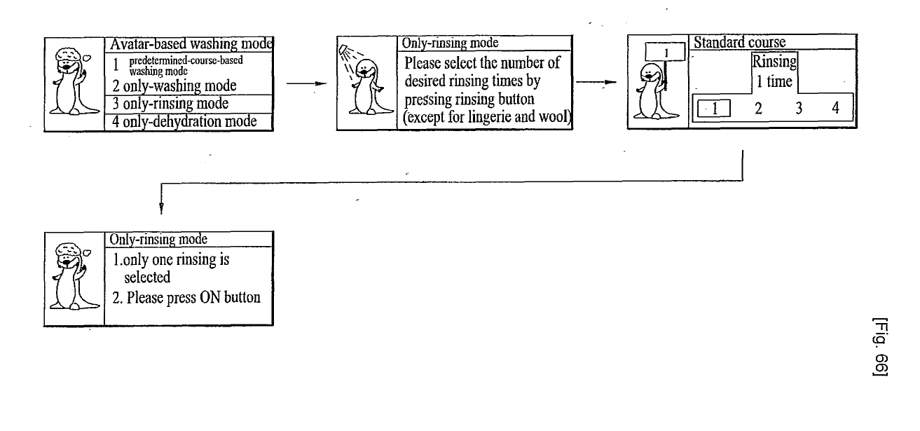

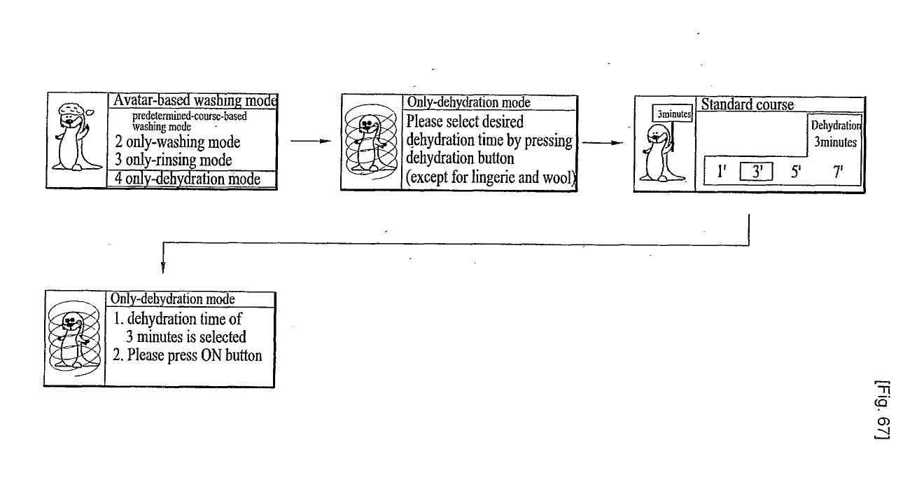

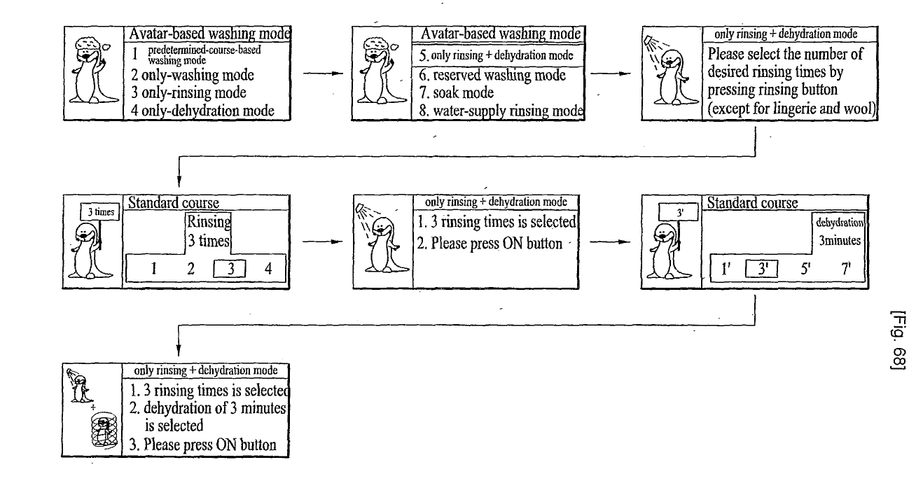

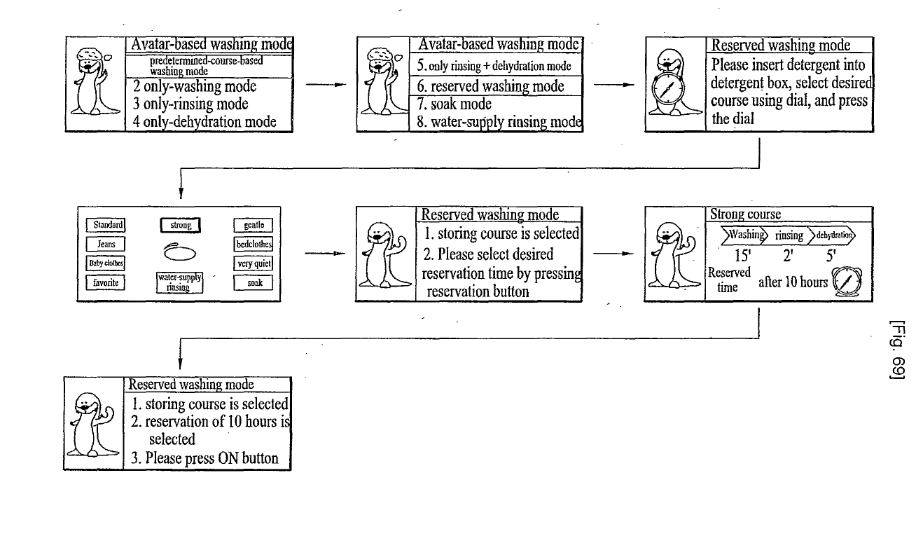

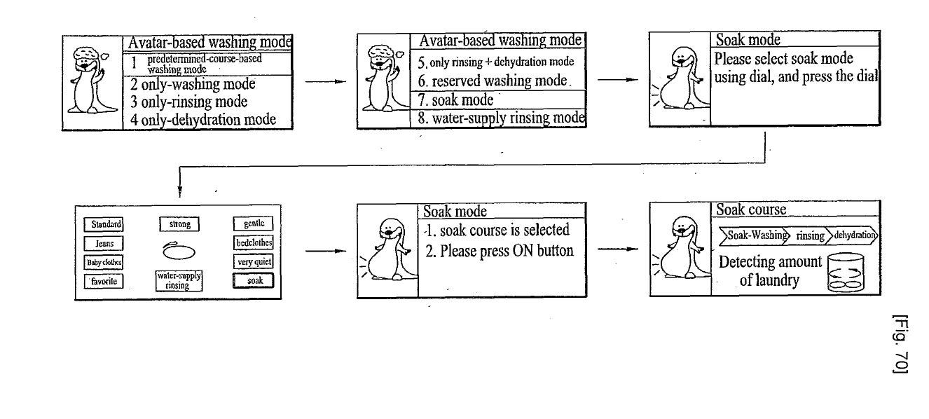

FIGS. 54˜62 are flow charts illustrating methods for providing a user with washing-course information using an avatar of a washing machine according to the present invention.

The method for providing the user with the washing-course information using the avatar of the washing machine can be basically classified into an avatar-specifying process and a washing-course directing process using the specified avatar.

In more detail, a specified avatar appears to sequentially inform the user of the washing course information of the washing machine. If the user desires to perform the washing course according to instructions of the avatar, a corresponding washing course is actually performed.

It is assumed that avatars appearing to inform the user of the washing courses are equal to avatars shown in FIG. 5 for the convenience of description.

The following avatar-based washing courses are disclosed for only illustrative purposes, and it should be noted that other examples may also be added to the above-mentioned examples as necessary.

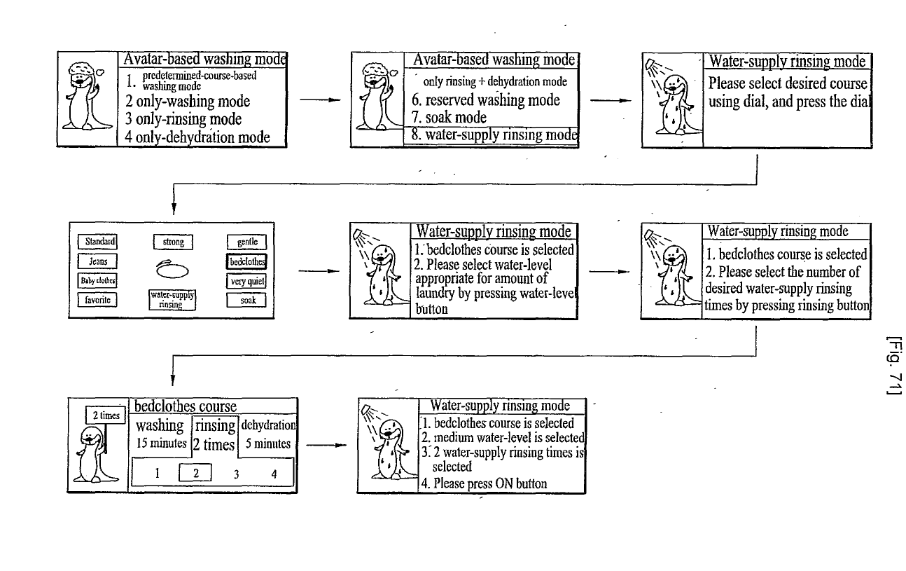

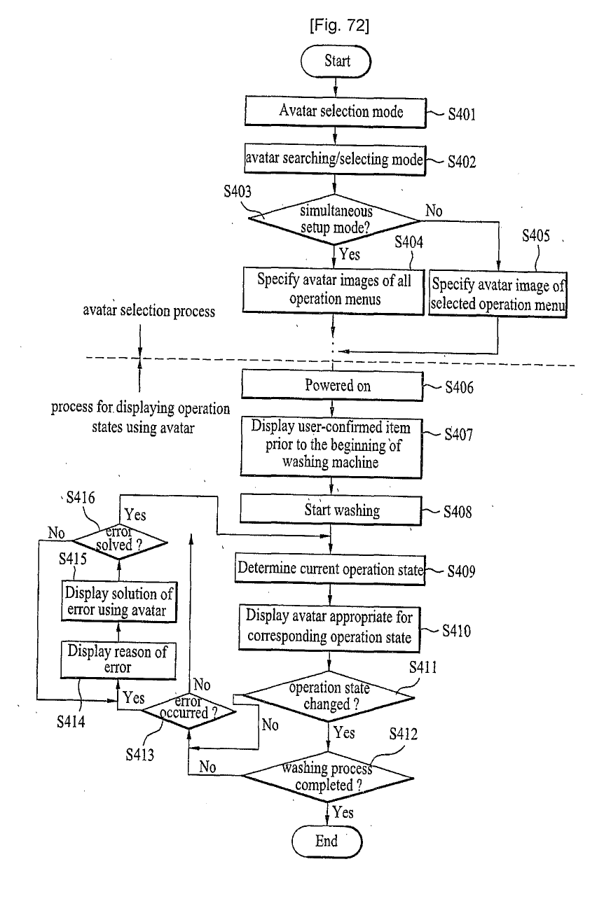

FIG. 63 shows exemplary avatar images classified according to individual washing courses so as to provide a user with washing-course information using an avatar of a washing machine according to the present invention.

FIGS. 64˜71 show exemplary screen images displayed when an avatar-based washing course is executed according to the present invention.

Referring to FIG. 54, the user powers on the washing machine at step S1. If the washing machine is powered on, the user selects an avatar-based washing course menu from among a plurality of menus displayed on the display at step S2.

If the avatar-based washing course menu is selected, a list corresponding to the avatar-based washing course is displayed at step S3.

In this case, there are a variety of avatar-based washing courses, for example, a predetermined-course-based washing mode, an only-washing mode, an only-rinsing, mode, an only-dehydration mode, a rinsing+dehydration mode, a reserved washing mode, a soak mode, and a water-supply rinsing mode.

The predetermined-course-based washing mode will hereinafter be described with reference to FIGS. 55˜64.

If the predetermined-course-based washing mode is selected from among the displayed list at step S4, a specified avatar appears to inform the user of a specific message “Please select desired course by pressing course button” at step S5.

It is determined whether the user presses the course button at step S6.

If the user does not press the course button within a predetermined period of time, an error message is displayed at step S7. If the user presses the course button within the predetermined period of time (e.g., if the user presses the Very Quiet Washing button of FIG. 64), the avatar informs the user of the selected course, and allows the user to enter a corresponding operation button (On-button) at step S8.

In this case, if the error message occurs, a current display image returns to a previous display image.

If the user presses the ON button at step S9, the washing process is performed at step S10, the rinsing process is performed at step S11, and the dehydration process is performed at step S12.

Needless to say, if the washing process, the rinsing process, and the dehydration process are sequentially executed after the user presses the ON button, the avatar may also inform the user of individual operation states.

The only-washing mode will hereinafter be described with reference to FIGS. 56˜65.

If the only-washing mode is selected from among the displayed list at step S13, a specified avatar appears to inform the user of a specific message “Please select desired washing time by pressing washing button (except for lingerie and wool)” at step S14.

If the user does not press the desired washing time button within a predetermined period of time, an error message is displayed at step S16. If the user presses the desired washing time button within the predetermined period of time at step S15, the avatar informs the user of the selected washing time, and allows the user to enter a corresponding operation button (On-button) at step S17.

In this case, if the error message occurs, a current display image returns to a previous display image.

If the user presses the ON button at step S18, only the washing process is performed during a user-defined time at step S19.

Needless to say, the avatar may also inform the user of individual operation states after the user presses the ON button.

The only-rinsing mode will hereinafter be described with reference to FIGS. 56˜66.

If the only-rinsing inode is selected from among the displayed list at step S20, a specified avatar appears to inform the user of a specific message “Please select the number of desired rinsing times by pressing rinsing button (except for lingerie and wool)” at step S21.

It is determined whether the user presses the rinsing button at step S22.

If the user does not press the desired rinsing button within a predetermined period of time, an error message is displayed at step S23.

If the error message is displayed, a current display image returns to a previous display image.

If the user presses the desired rinsing button within the predetermined period of time at step S22, the avatar informs the user of the number of selected rinsing times, and allows the user to enter a corresponding operation button (On-button) at step S24.

If the user presses the ON button at step S25, the rinsing process is performed according to the user-defined rinsing times at step S26.

The only-dehydration mode will hereinafter be described with reference to FIGS. 58˜67.

If the user selects the only-dehydration mode from among the displayed list at step S27, a specified avatar appears to inform the user of a specific message “Please select desired dehydration time by pressing dehydration button (except for lingerie and wool)” at step S28.

It is determined whether the user presses the dehydration button to select the desired dehydration time at step S29.

If the user does not select the desired dehydration time within a predetermined period of time, an error message is displayed at step S30.

If the user selects the desired dehydration time within the predetermined period of time, the avatar informs the user of the selected dehydration time, and allows the user to enter a corresponding operation button (On-button) at step S31.

If the user presses the ON button at step S32, the dehydration process is performed during the user-selected dehydration time at step S33.

Needless to say, the avatar may also inform the user of individual dehydration operation states after the user presses the ON button.

The “rinsing+dehydration” mode will hereinafter be described with reference to FIGS. 59˜68.

If the user selects the rinsing+dehydration mode from among the displayed list at step S34, a specified avatar appears to inform the user of a specific message “Please select the number of desired rinsing times by pressing rinsing button (except for lingerie and wool)” at step S35.

It is determined whether the user presses the rinsing button to select the number of desired rinsing times at step S36.

If the user does not press the desired rinsing button within a predetermined period of time at step S36, an error message is displayed at step S37.

If the error message is displayed, a current display image returns to a previous display image.

If the user presses the desired rinsing button within the predetermined period of time at step S36, the avatar informs the user of the number of selected rinsing times, and allows the user to enter the dehydration button to select a desired dehydration time at step S38.

It is determined whether the user selects the desired dehydration time by pressing the dehydration button at step S39.

If the user does not select the desired dehydration time within the predetermined period of time at step S39, an error message is displayed at step S39.

If the error message is displayed, a current display image returns to a previous display image.

If the user selects the desired dehydration time by pressing the dehydration button within the predetermined period of time, the avatar informs the user of the number of selected rinsing times and the selected dehydration time, and allows the user to enter a corresponding operation button (On-button) at step S41.

If the user presses the ON button at step S42, the rinsing process is performed the number of user-selected rinsing times at step S43, and the dehydration process is performed during the user-selected dehydration time at step S44, such that the rinsing+dehydration mode is terminated.

Needless to say, the avatar may also inform the user of individual operation states of the rinsing process and the dehydration process after the user presses the ON button.

The reserved washing mode will hereinafter be described with reference to FIGS. 60˜69.

If the user selects the reserved washing mode from among the displayed list at step S45, a specified avatar appears to inform the user of a specific message “Please select desired course by pressing course button after putting detergent in detergent box” at step S46.

It is determined whether the user selects a desired course at step S47.

If the user does not select the desired course within a predetermined period of time at step S47, an error message is displayed at step S48.

If the error message is displayed, a current display image returns to a previous display image.

If the user selects the desired course within the predetermined period of time at step S47, the avatar informs the user of the selected course (e.g., the strong course in FIG. 11), and informs the user with a specific message “Please select desired reservation time by pressing reservation button” at step S49.

It is determined whether the user selects the desired reservation time by pressing the reservation button at step S50.

If the user does not select the desired reservation time within the predetermined period of time at step S50, an error message is displayed at step S51.

If the error message is displayed, a current display image returns to a previous display image.

If the user selects the desired reservation time by pressing the reservation button within the predetermined period of time at step S50, the avatar informs the user of the selected source and the reserved time, and allows the user to enter a corresponding operation button (On-button) at step S52.

If the user presses the ON button at step S53, the washing machine enters a reservation standby mode according to the user-selected reservation information at step S54, such that the washing course is performed at step S55, the rinsing course is performed at step S56, and the dehydration process is performed at step S57.

Needless to say, the avatar may also inform the user of individual operation states of the washing-, rinsing-, and dehydration-processes after the user presses the ON button.

The soak mode will hereinafter be described with reference to FIGS. 61˜70.

If the user selects the soak mode from among the displayed list at step S58, a specified avatar appears to inform the user of a specific message “Please select soak course by pressing course button at step S59.

It is determined whether the user selects the soak course by pressing the course button within a predetermined period of time at step S60.

If the user does not select the soak course within the predetermined period of time at step S60, an error message is displayed at step S61.

If the error message is displayed at step S61, a current display image returns to a previous display image.

If the user selects the soak course within the predetermined period of time at step S60, the avatar informs the user of the selected course, and allows the user to enter an operation button (i.e., ON button) at step S62.

If the user presses the ON button at step S63, the washing machine detects an amount of laundry contained in the drum at step S64, and provides the drum with water on the basis of the detected amount of laundry at step S65.

Thereafter, if the water-supply operation is completed, the soak process is performed during the predetermined period of time at step S66, such that the washing course is performed at step S67, the rinsing course is performed at step S68, and the dehydration process is performed at step S69.

The water-supply rinsing mode will hereinafter be described with reference to FIGS. 62˜71.

If the user selects the water-supply rinsing mode from among the displayed list at step S70, a specified avatar appears to inform the user of a specific message “Please select desired course by pressing course button at step S71.

It is determined whether the user selects the desired course by pressing the course button within a predetermined period of time at step S72.

If the user does not select the desired course within the predetermined period of time at step S72, an error message is displayed at step S73.

If the error message is displayed at step S73, a current display image returns to a previous display image.

If the user selects the desired course within the predetermined period of time at step S72, the avatar informs the user of the selected course, and informs the user with a specific message “Please select desired water-level by pressing water-level button at step S74.

If the user does not select the desired water-level within the predetermined period of time at step 75, an error message is displayed at step S76.

If the error message is displayed at step S76, a current display image returns to a previous display image.

If the user selects the desired water-level at step S75, the avatar informs the user of a specific message “Please select the number of water-supply rinsing times by pressing rinsing button” at step S77.

If the user does not select the number of desired water-supply rinsing times within the predetermined period of time at step 78, an error message is displayed at step S79.

If the error message is displayed at step S79, a current display image returns to a previous display image.

If the user selects the number of desired water-supply rinsing times within the pre-determined period of time at step S78, the avatar informs the user of the selected course, the selected water-level, and the selected number of water-supply rinsing times, and allows the user to enter an operation button (i.e., ON button) at step S80.

If the user presses the ON button at step S81, the washing course is performed at step S82, the rinsing course is performed at step S83, and the dehydration process is performed at step S84, according to the user-selected washing condition information.

As described above, the washing machine according to the present invention simultaneously displays the main avatar and the sub-avatar, instead of displaying current operation states using only one avatar, such that it can provide the user with more accurate information.

As described above, it is assumed that the above-mentioned processes for displaying operation states using the avatar according to the present invention may display only the avatar on the display.

Furthermore, the above-mentioned processes for displaying operation states using the avatar may display specific characters on the display simultaneously displaying the avatar on the display, and at the same time may output voice signals as necessary.

The above-mentioned processes for displaying operation states using the avatar according to the present invention can provide the user with a variety of washing course methods, resulting in greater convenience of a beginner user or all users of the washing machines.

FIG. 72 is a flow chart illustrating a method for providing a user with attention and solution information using an avatar of a washing machine according to the present invention.

The method for providing the user with the attention information using the avatar can be basically classified into a process for specifying an avatar appropriate for attention categories, and a process for displaying washing information using the specified avatar.

The method for providing the user with the solution information using the avatar can be basically classified into a process for specifying an avatar capable of informing the user of the error occurrence and solution information, and a process for displaying the error occurrence and solution information using the specified avatar.

In this case, the washing information indicated by the avatar includes the user-confirmed items and error-state information. The error-state information includes errors of water-supplying and draining operations and errors of the dehydration operation.

The avatar, images of individual basic processes of the washing machine, the avatar images of operation states of each process, and the user-specified avatar images of individual washing courses have previously been disclosed in FIGS. 3 and 9.

FIG. 4 shows exemplary avatar images of individual processes of a washing machine according to the present invention. FIG. 6 shows exemplary avatar images associated with individual operation states of a washing machine according to the present invention.

FIG. 10 shows exemplary avatar images classified according to individual washing courses of a washing machine according to the present invention.

FIGS. 29˜36 show exemplary screen images displayed when items to be confirmed by a user (i.e., user-confirmed items) prior to the beginning of a washing process are explained using an avatar according to the present invention.

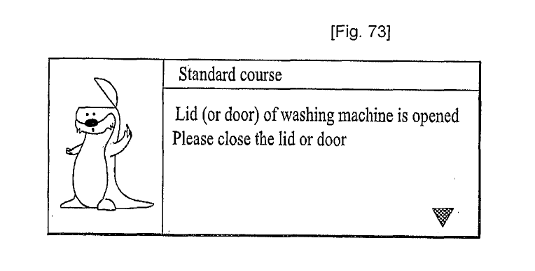

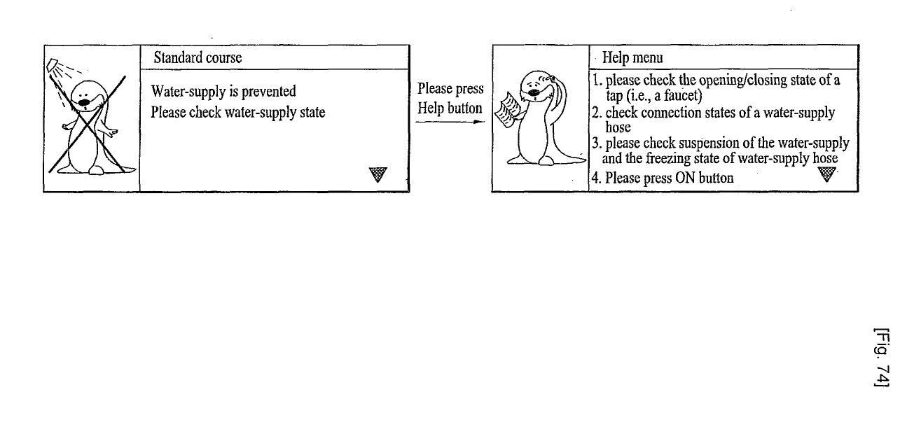

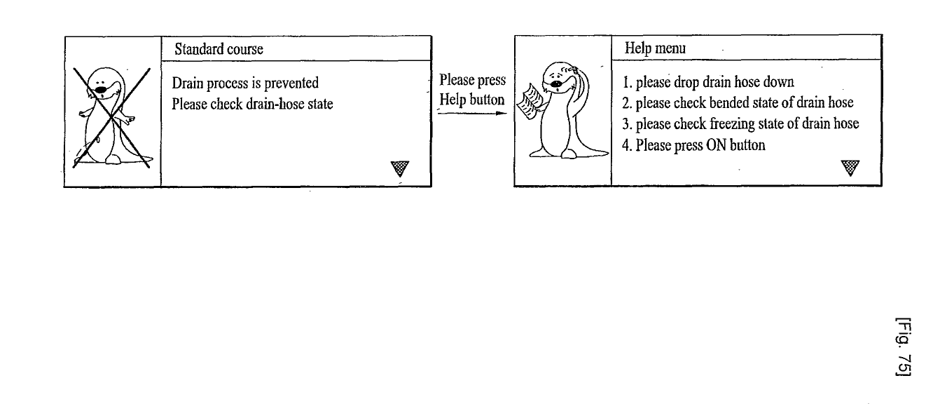

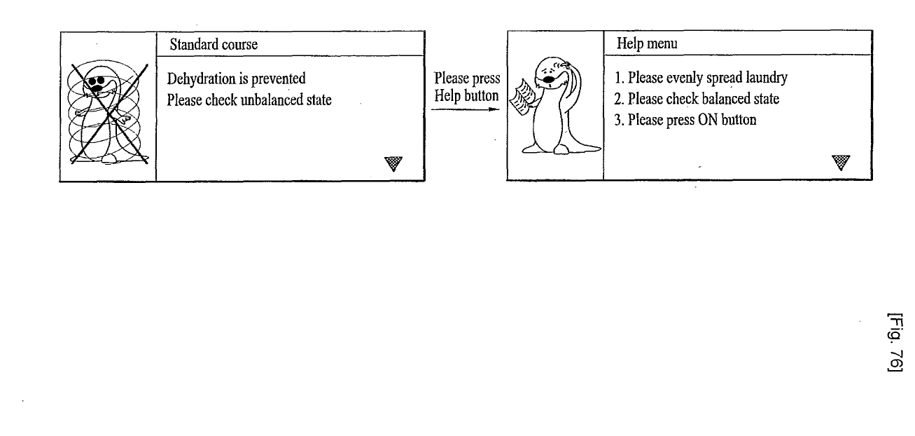

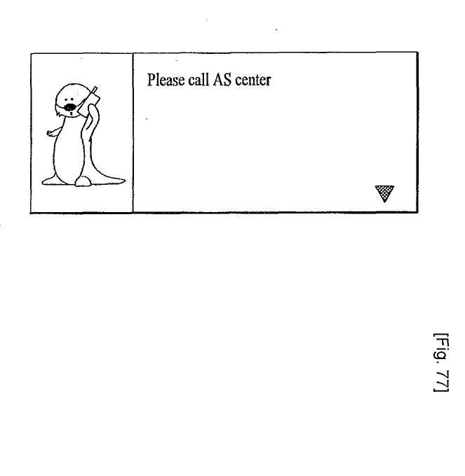

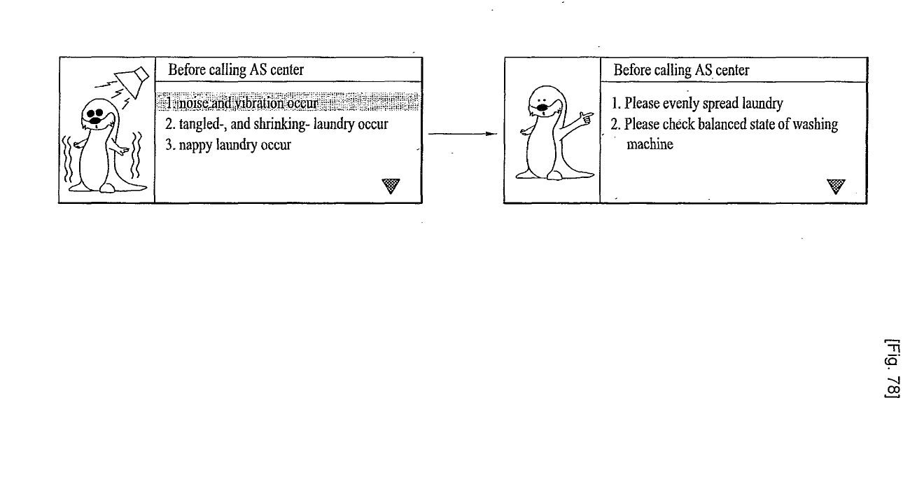

FIGS. 73˜77 show exemplary avatar images for providing a user with category- and solution-information of individual errors of a washing machine according to the present invention.

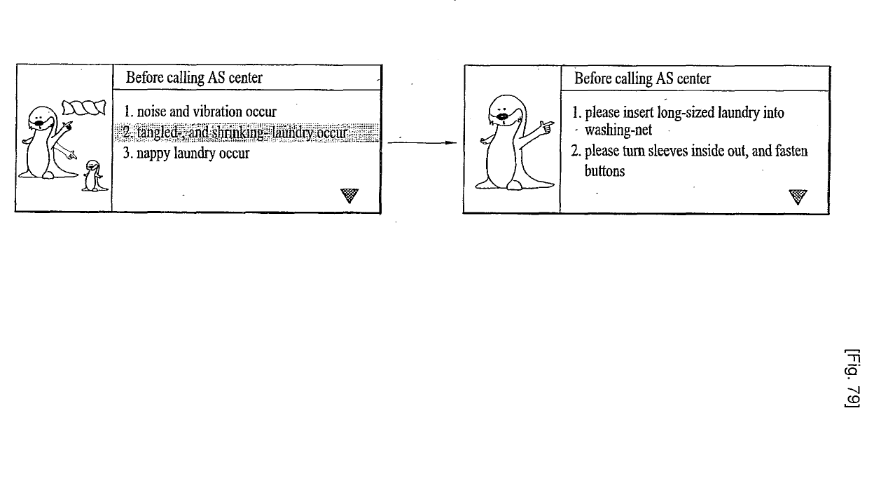

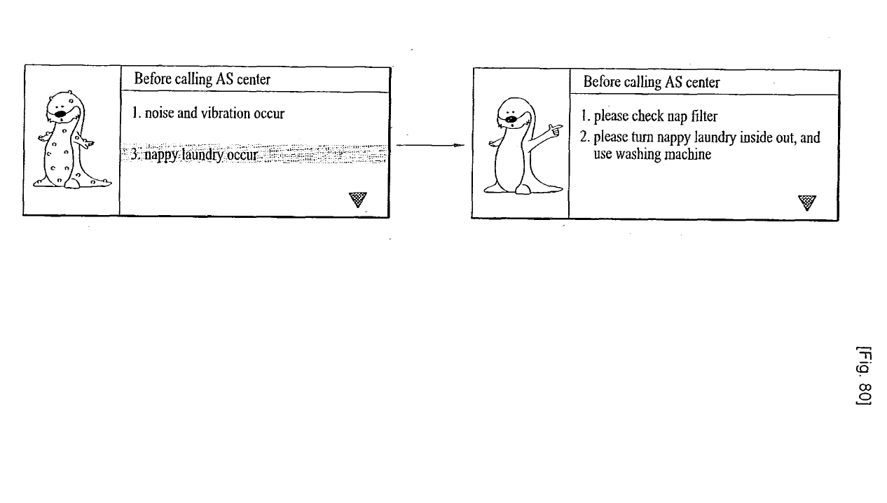

FIGS. 78˜80 show exemplary avatar images illustrating checkup points required to be inspected by a user before the user reports the occurrence of errors to an after-sale service (AS) center of the manufacturing company of the washing machine according to the present invention.

Referring to FIG. 72, the above-mentioned process for specifying the avatar enters an avatar selection mode at step S401, and searches for/selects a desired avatar from among avatars stored in the avatar information storage unit at step S402.

In this case, the above-mentioned avatar searching/selecting process may establish not only the motion, size, and speed of the avatar, but also a background color and a background music of the avatar.

Also, the above-mentioned avatar searching/selecting process may be executed by information stored in the avatar-information storage unit, and may be connected to a server for providing avatar information or a server of a manufacturing company of the washing machine via an external device, such that it may be executed simultaneously with downloading the avatar information from the server.

The avatar searching/selecting process determines whether an avatar image setup is a simultaneous setup mode at step S403.

If the avatar image setup is equal to the simultaneous setup mode at step S403, avatar images of all the operation menus are changed to selected images, such that the resultant avatar images are determined at step S404.

If the avatar image setup is different from the simultaneous setup mode at step S403, avatar images of the selected washing information are changed to selected images, such that the resultant avatar images are determined at step S405.

If the avatar image setup is executed by an individual setup mode instead of the simultaneous setup mode, different avatars display individual washing information according to operation menus.

If the washing process is performed by a user under the aforementioned condition that the avatar image setup has been completed, the process for displaying the washing information using the avatar is executed as follows.

Referring to FIG. 72, if the washing machine is powered on to perform the washing process at step S406, it is determined whether a current operation mode is the attention-information display mode, such that a specific avatar appears to inform the user of the attention information of a user-desired item at step S407.

The above-mentioned attention information is displayed prior to the beginning of the washing operation, and may not be displayed if the user does not desire to display the attention information.

In other words, if the user selects to display the attention information, the washing information associated with the user-confirmed items of FIGS. 29˜36 is displayed,

There are a variety of sub-menus of the user-confirmed items, for example, a laundry-pocket item, a washable-laundry item, a washing-net use item, a separated-washing item, a waterproofing-fiber washing item, a tangled-laundry reduction item, a zip-cloth washing item, and a sweater-washing item, etc.

If the user selects any one of the above-mentioned items by referring to the above-mentioned user-confirmed items, and the selected washing process begins at step S408, current operation states of the washing machine are determined at step S409.

A specified avatar appropriate for the corresponding operation state is displayed on the display of the washing machine at step S410.

In this case, the motion and environment of the avatar displayed on the display are controlled by information predetermined by the user.

As described above, the process for displaying operation states using the avatar is continuously executed until a current operation state is changed to another operation state.

The above-mentioned process for displaying operation states using the avatar is executed using avatar images as shown in FIGS. 4, 6, and 10.

If the current operation state is changed to another operation state at step S411, and all the washing operations are not completed at step S412, the current operation state is re-determined such that an avatar appropriate for the corresponding operation state is displayed.

If an unexpected error occurs in the washing process at step S413, the reason of the error occurrence is displayed at step S414 as shown in FIGS. 73˜77. If the user enters the “Help” button, a specific avatar appears to inform the user of the solution of the error at step S415.

If the user solves the error by referring to the avatar for providing the error solution information, the washing operation is re-continued at step S416.

For example, if a door of the washing machine is opened as shown in FIG. 73, a specific avatar for informing the user of the door closing command is displayed.

If the water-supply operation is not achieved as shown in FIG. 74, a specific avatar for informing the user of the water-supply state check command is displayed.

If the user presses the Help button, a specific avatar commands to the user to check the opening/closing state of a tap (i.e., a faucet), commands the user to check connection states of a water-supply hose, commands the user to check suspension of the water-supply, commands the user to check the freezing state of the water-supply hose, and finally allows the user to enter the operation button (i.e., ON button).

If the draining operation is not performed as shown in FIG. 74, a specific avatar commands the user to check a drain hose of the washing machine. If the user presses the Help button, a specific avatar appears, such that it commands the user to check the location-, bending-, and freezing-information of the drain hose.

If the dehydration process is abnormally performed as shown in FIG. 76, a specific avatar appears to command the user to check an unbalanced state of the washing machine. If the user presses the Help button, the avatar commands the user to evenly spread laundry, and command the user to check a balanced state of the washing machine.

If the error is not solved even if the avatar has informed the user of the above-mentioned solution information, the user reports the error information to the AS (After-sale Service) center of the manufacturing company of the washing machine, as shown in FIG. 77.

If required, the avatar may also automatically inform the AS center of the error information. In other words, if the user selects a specific command or button of the washing machine, the washing machine may gain access to the server of the manufacturing company to report the error information to the AS center.

In the case where other errors occur during the operation time of the washing machine and the user is unable to solve the errors, the user reports the error information to the AS center, such that a repairman of the AS center can repair the erroneous washing machine of the user.

As described above, the avatar can inform the user of a variety of solutions of errors of the washing machine, before the user notifies the AS center of the error or faulty operation of the washing machine.

In other words, if excessive noise or vibration occurs in the washing machine, or if tangled laundry, shrinking laundry, and laundry suffering from napping occur in the washing machine, the avatar informs the user of effective usages of the washing machine to solve these problems before calling the AS center, as shown in FIGS. 78˜80.

As described above, the process for providing the user of the solution information of errors may be displayed on the display using only the avatar, however, it should be noted that the avatar, voice signals associated with the avatar, and characters associated with the avatar may be simultaneously notified to the user as necessary.

Only the above-mentioned avatar images for informing the user of the user-confirmed items, the error occurrence, and the solution information are displayed on the display of the washing machine. It should be noted that the above-mentioned avatar images have been disclosed for only illustrative purposes.

The above-mentioned avatars may be displayed on the display to inform the user of a variety of information. Also, the avatars, associated voice signals, and associated characters may also be simultaneously notified to the user as necessary.

### INDUSTRIAL APPLICABILITY

As apparent from the above description, the information display control method using the avatar according to the present invention has the following effects.

Basic usages of the washing machine, and various methods for displaying operation- and control-states of the washing machine will be indicated by at least one dynamic character, such that a user of the washing machine can easily recognize necessary information of the washing machine, resulting in not only increased information transmission characteristics of the washing machine but also emphasized entertainment elements required by modern consumers of the washing machine.

Specifically, the motion of selected avatars is controlled according to a variety of factors (i.e., washing- and drying-process states of the washing machine, operation-state variation of a motor and a load drive), such that the user can recognize current operation states of the washing machine within a short period of time.

Also, the present invention informs the user of a variety of information required for the washing machine using only the avatar without using a user manual of the washing machine, such that the user can effectively use the washing machine.

The washing machine according to the present invention provides the user with the avatar-based washing course, and allows the user to easily check user-defined washing conditions, resulting in greater convenience of the user.

The washing machine according to the present invention informs the user of error- and solution-information of the washing machine using the avatar during the operation time of the washing machine, such that the user can quickly and correctly recognize the error- and solution-information by referring to the avatar.

The washing machine according to the present invention gains access to the server using external devices, such that it can download/store new avatars, resulting in more avatars being available for the washing machine.

Also, a variety of operation states of the washing machine are displayed on the display of the washing machine according to the present invention, resulting in increased competitive power.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

1. A method for controlling an information display using an avatar of a washing machine equipped with a display capable of indicating information associated with operation states of the washing machine, the method comprising the steps of:
a) specifying an avatar image according to an operation menu; and
b) displaying the specified avatar according to operation states of the washing machine.

2. The method according to claim 1, wherein the displayed avatar includes a specific format and motion capable of specifying a corresponding operation menu.

3. The method according to claim 1, wherein the step a) for specifying the avatar image includes the step of:
selecting the avatar image once, such that avatar images of all operation menus of the washing machine are changed to other avatar images.

4. The method according to claim 1, wherein the step a) for specifying the avatar image includes the step of:
changing only the avatar image of the selected operation menu to another avatar image, such that the changed avatar image is specified.

5. The method according to claim 1, wherein the step a) for specifying the avatar image includes the steps of:
searching for/selecting the avatar image; and
establishing not only the motion, size, and speed of the avatar, but also a background color and a background music of the avatar.

6. The method according to claim 5, wherein the step a) for specifying the avatar image includes the steps of:
searching for contents stored in an avatar information storage unit of the washing machine; and
selecting the searched contents.

7. The method according to claim 5, wherein the step a) for specifying the avatar image includes the steps of:
allowing the washing machine to access a server for providing avatar information; and
searching for/selecting the avatar image.

8. The method according to claim 7, wherein the selected avatar information is automatically stored in an avatar information storage unit of the washing machine.

9. The method according to claim 1, wherein the step b) for displaying the avatar according to operation states of the washing machine includes the steps of:
b1) if the washing machine is driven after the avatar image is specified, determining a current operation menu state;
b2) displaying the specified avatar appropriate for the corresponding operation menu state on the display; and
b3) if the corresponding operation menu is completely operated, determining a next operation menu state, and re-displaying the specified avatar.

10. The method according to claim 9, wherein the step b) for displaying the avatar according to operation states of the washing machine further includes the step of: generating a specific background music during a predetermined start time or end time of an avatar display period during which the avatar appropriate for the operation state of a corresponding menu is displayed, such that a user can recognize the beginning or ending of the corresponding operation menu by listening to the background music.

11. The method according to claim 1, wherein the avatar has a specific format and motion capable of specifying the avatar, wherein the format and the motion are distinguished from each other by a basic operation menu, wherein the basic operation menu includes a washing process, dehydration process, a eater-supply process, a drain process, a drying process, a steam washing process.

12. The method according to claim 1, wherein the avatar has a specific format and motion capable of specifying the avatar, wherein the format and the motion are distinguished from each other by an operation menu, wherein the operation menu includes:
a remaining time menu for displaying a remaining time of a washing-, dehydration-, rinsing-, or drying-process, or a remaining time of a total washing time;
an error occurrence menu for displaying occurrence of an error or faulty operation of the washing machine during each process;
a current temperature menu for displaying an inner temperature of a drum or a water temperature during a current process; and
an operation menu explanation menu for informing the user of simple operation methods of the washing machine, or informing the user of a corresponding menu.

13. The method according to claim 1, further comprising the step of:
if a user clicks on the displayed avatar by moving a cursor from a current location to another location or touches the corresponding avatar on a touch-screen, displaying more detailed sub-menu avatars on the display of the washing machine.

14. The method according to claim 13, wherein a sub-avatar corresponding to the sub-menu and a main-avatar corresponding to a main-menu are simultaneously displayed on the display of the washing machine.

15. The method according to claim 1, wherein the avatar for indicating operation states of the washing machine is displayed, and at the same time voice signals associated with the avatar are generated and characters associated with the avatar are also displayed.

16. The method according to claim 1, wherein the avatar for indicating operation states of the washing machine is displayed, independent of generating voice signals associated with the avatar and displaying characters associated with the avatar.

17. A method for controlling an information display using an avatar of a washing machine equipped with a display capable of indicating washing information, the method comprising the steps of:
a) specifying an avatar image according to categories of the washing information; and
b) if a user selects a desired menu in a washing-information explanation mode, displaying a specified avatar appropriate for the selected menu on the display, such that it informs the user of information associated with the selected menu.

18. The method according to claim 17, wherein the displayed avatar includes a specific format and motion capable of specifying the selected menu.

19. The method according to claim 17, wherein the avatar for indicating the washing information is displayed, and at the same time voice signals associated with the avatar are generated and characters associated with the avatar are also displayed.

20. The method according to claim 17, wherein the avatar for indicating the washing information is displayed, independent of generating voice signals associated with the avatar and displaying characters associated with the avatar.

21. The method according to claim 17, wherein the user is able to a main menu in the washing information explanation mode, wherein the main menu includes:
a first menu for explaining washing courses;
a second menu for explaining button usages of the washing machine; and
a third menu for explaining common-sense washing information.

22. The method according to claim 21, wherein the second menu for explaining the button usages includes a plurality of sub-menus of a button selected from among a variety of function buttons, i.e., a washing button, a rinsing button, a dehydration button, a flowing-water-force button, a water-level button, an On/Off button, and a reservation button.

23. The method according to claim 22, wherein:
the buttons to be explained are selected by the user via the sub-menus displayed on the screen, or may be selected by the user who presses actual buttons in the washing information explanation mode.

24. The method according to claim 21, wherein the third menu for explaining the common-sense washing information includes a variety of sub-menus, i.e., a menu associated with a method for removing stains from the laundry, a menu associated with a method for explaining user-confirmed items prior to the beginning of the washing course, a menu associated with a method for explaining usages of a detergent, and a menu associated with a method for reading washing information indicated on the laundry.

25. The method according to claim 21, wherein:
if the user selects the washing information explanation mode when the washing process begins or is in progress, an avatar capable of specifying a corresponding menu appears, such that it provides the user with necessary information.

26. The method according to claim 25, wherein:
if the user presses a “Return” key after acquiring desired information, a current operation returns to initial screen images or original operation states.

27. The method according to claim 21, wherein:
under a condition that the explanation of either a sub-menu selected from the main menu of the washing-course explanation or a sub-menu selected from the main menu of button usages of the washing machine is in progress or is completed, if the user re-selects the corresponding sub-menu, operations of the selected course or operations associated with the pressed button are performed.

28. A method for controlling an information display using an avatar of a washing machine equipped with a display capable of indicating washing course information, the method comprising the steps of:
a) displaying a plurality of menus for sequentially providing a user with information of all washing processes; and
b) if the user selects a desired menu from among the displayed menus, displaying a specified avatar appropriate for the selected menu on the display, such that it sequentially informs the user of necessary information.

29. The method according to claim 28, wherein the avatar includes a specific format and motion capable of specifying the selected menu.

30. The method according to claim 28, wherein:
if the user selects the desired menu by referring to information directed by the avatar, a process corresponding to the user-selected menu is actually performed.

31. The method according to claim 28, wherein the avatar for indicating the washing course is displayed, and at the same time voice signals associated with the avatar are generated and characters associated with the avatar are also displayed.

32. The method according to claim 28, wherein the avatar for indicating the washing course is displayed, independent of generating voice signals associated with the avatar and displaying characters associated with the avatar.

33. The method according to claim 28, wherein the avatar provides the user with explanation of the selected menu, commands the user to check previous input data, and commands to user to enter a currently-required command.

34. The method according to claim 28, wherein the menus for sequentially providing the user with necessary washing-process information are a predetermined-course-based washing mode, an only-washing mode, an only-rinsing mode, an only-dehydration mode, a rinsing+dehydration mode, a reserved washing mode, a soak mode, and a water-supply rinsing mode.

35. The method according to claim 34, wherein the predetermined-course-based washing mode includes the steps of:
a) displaying a specified avatar to inform the user of a specific message for commanding the user to select a desired course, and allowing the user to select the desired course;
b) informing, by the avatar, the user of the selected course, and commanding the user to enter an operation button; and
c) if the user presses the operation button by referring to information directed by the avatar, and sequentially performing a selected washing course.

36. The method according to claim 34, wherein the only-washing mode includes the steps of:
a) displaying a specified avatar to inform the user of a specific message for commanding the user to select a desired washing time, and allowing the user to select the desired washing time;
b) informing, by the avatar, the user of the selected washing time, and commanding the user to press an operation button; and
c) if the user presses the operation button by referring to information directed by the avatar, and sequentially performing the washing process during the selected washing time.

37. The method according to claim 34, wherein the only-rinsing mode includes the steps of:
a) displaying a specified avatar to inform the user of a specific message for commanding the user to select the number of desired rinsing times, and allowing the user to select the number of desired rinsing times;
b) informing, by the avatar, the user of the selected rinsing times, and commanding the user to press an operation button; and
c) if the user presses the operation button by referring to information directed by the avatar, and sequentially performing the only-rinsing process according to the user-selected rinsing times.

38. The method according to claim 34, wherein the only-dehydration mode includes the steps of:
a) displaying a specified avatar to inform the user of a specific message for commanding the user to select a desired dehydration time, and allying the user to select the desired dehydration time;
b) informing, by the avatar, the user of the selected dehydration time, and commanding the user to press an operation button; and
c) if the user presses the operation button by referring to information directed by the avatar, and sequentially performing the only-dehydration process during the user-selected dehydration time.

39. The method according to claim 34, wherein the rinsing+dehydration mode includes the steps of:
a) displaying a specified avatar to inform the user of a specific message for commanding the user to select the number of desired rinsing times, and allowing the user to select the desired rinsing times;
b) informing, by the avatar, the user of the selected rinsing times, and providing a message for commanding the user to select a desired dehydration time;
c) if the user selects the desired dehydration time, informing the user of the selected dehydration time using the avatar, and commanding the user to press an operation button; and
d) if the user presses the operation button by referring to information directed by the avatar, sequentially performing the rinsing process and the dehydration process on the basis of the selected rinsing times and the selected dehydration time.

40. The method according to claim 34, wherein the reserved washing mode includes the steps of:
a) displaying a specified avatar to inform the user of a specific message for commanding the user to select a desired washing course, and allowing the user to select the desired course;
b) informing, by the avatar, the user of the selected washing course, and providing a message for commanding the user to select a desired reservation time;
c) informing, by the avatar, the user of the selected washing course and reservation time, and commanding the user to press an operation button; and
d) if the user presses the operation button by referring to information directed by the avatar, entering a reservation standby mode on the basis of the selected reservation time, and sequentially performing the washing process according to the selected washing course.

41. The method according to claim 34, wherein the soak mode includes the steps of:
a) displaying a specified avatar to inform the user of a specific message for commanding the user to select a desired course, and allowing the user to select the desired course by referring to information directed by the avatar;
b) informing, by the avatar, the user of the selected course, and providing a message for commanding the user to press an operation button;
c) if the user presses the operation button by referring to information directed by the avatar, detecting an amount of laundry contained in the washing machine, and providing the washing machine with water on the basis of the detected amount of laundry; and
d) performing the soak mode after providing the washing machine with the water, and performing the washing process.

42. The method according to claim 34, wherein the water-supply rinsing mode includes the steps of:
a) displaying a specified avatar to inform the user of a specific message for commanding the user to select a desired course, and allowing the user to select the desired course by referring to information directed by the avatar;
b) informing, by the avatar, the user of the selected course, and providing a message for commanding the user to select a desired water-level;
c) if the user selects the desired water-level, commanding the user to select the number of desired water-supply rinsing times using the avatar, such that the user selects the number of desired water-supply rinsing times;
d) informing, by the avatar, the user of the selected course, water-level, and water-supply rinsing times, and commanding the user to press an operation button; and
e) if the user presses the operation button by referring to information directed by the avatar, sequentially performing the washing process, the water-supply process, and the rinsing process according to user-selected conditions.

43. A method for controlling an information display using an avatar of a washing machine equipped with a display capable of indicating information associated with operation states of the washing machine, the method comprising the steps of:
a) specifying an avatar image for indicating washing information; and
b) if a user enters a command for displaying user-confirmed items prior to the beginning of a washing process, displaying the specified avatar on the display, such that it informs the user of information associated with the user-confirmed items.

44. The method according to claim 43, wherein the avatar includes a specific format and motion capable of specifying each of the user-confirmed items.

45. The method according to claim 43, wherein the step a) for specifying the avatar image includes the step of:
establishing not only the motion, size, and speed of the avatar, but also a background color and a background music of the avatar.

46. The method according to claim 43, wherein the avatar for indicating the washing information is displayed, and at the same time voice signals associated with the avatar are generated and characters associated with the avatar are also displayed.

47. The method according to claim 43, wherein the avatar for indicating the washing information is displayed, independent of generating voice signals associated with the avatar and displaying characters associated with the avatar.

48. The method according to claim 43, wherein the user-confirmed items prior to the beginning of the washing process are a laundry-pocket item, a washable-laundry item, a washing-net use item, a separated-washing item, a waterproofing-fiber washing item, a tangled-laundry reduction item, a zip-cloth washing item, and a sweater-washing item.

49. The method according to claim 48, wherein the user-confirmed items are displayed only when the user selects the command for displaying the user-confirmed items.

50. The method according to claim 48, wherein the user-confirmed items are displayed prior to the beginning of the washing process.

51. A method for controlling an information display using an avatar of a washing machine equipped with a display capable of indicating information associated with operation states of the washing machine, the method comprising the steps of:
a) specifying an avatar image for indicating washing information; and
b) if an unexpected error occurs in an operation time of the washing machine, displaying the specified avatar corresponding to the error on the display, and providing the user with information of the error.

52. The method according to claim 51, wherein the avatar includes a specific format and motion capable of specifying the error.

53. The method according to claim 51, wherein the step a) for specifying the avatar image includes the step of:
establishing not only the motion, size, and speed of the avatar, but also a background color and a background music of the avatar.

54. The method according to claim 51, wherein the step a) for specifying the avatar image includes the steps of:
searching for contents stored in an avatar information storage unit of the washing machine; and
selecting the searched contents.

55. The method according to claim 51, wherein the step a) for specifying the avatar image includes the steps of:
allowing the washing machine to access a server for providing avatar information; and
searching for/selecting the avatar image.

56. The method according to claim 51, wherein the error information directed by the avatar includes reason- and solution-information of the error.

57. The method according to claim 56, further comprising the step of:
if the error is not solved by the solution information directed by the avatar, allowing the avatar to notify an after-sale service (AS) center of the error information.

58. The method according to claim 57, further comprising the step of:
allowing the avatar to, inform the user of check points before notifying the AS center of the error information.

59. The method according to claim 51, wherein the avatar for indicating the error information is displayed, and at the same time voice signals associated with the avatar are generated and characters associated with the avatar are also displayed.

60. The method according to claim 51, wherein the avatar for indicating the error information is displayed, independent of generating voice signals associated with the avatar and displaying characters associated with the avatar.

61. The method according to claim 51, wherein the step b) for displaying the avatar according to operation states of the washing machine includes the steps of:
b1) if the washing machine is driven after the avatar image is specified, determining a current operation menu state;
b2) displaying the specified avatar appropriate for the corresponding operation menu state on the display; and
b3) if the corresponding operation menu is completely operated, determining a next operation menu state, and re-displaying the specified avatar.

62. The method according to claim 61, wherein the step b) for displaying the avatar according to operation states of the washing machine further includes the step of: generating a specific background music during a predetermined start time or end time of an avatar display period during which the avatar appropriate for the operation state of a corresponding menu is displayed, such that a user can recognize the beginning or ending of the corresponding operation menu by listening to the background music.
